(19) United States
(12) Patent Application Publication
(10) Pub. No.: US 2016/0204439 A1
(43) Pub. Date: Jul. 14, 2016

(54) SECONDARY-BATTERY BINDER COMPOSITION, SLURRY COMPOSITION FOR SECONDARY-BATTERY ELECTRODE, SECONDARY-BATTERY NEGATIVE ELECTRODE, AND SECONDARY BATTERY

(71) Applicant: ZEON CORPORATION, Chiyoda-ku, Tokyo (JP)

(72) Inventor: Kenya SONOBE, Chiyoda-ku, Tokyo (JP)

(73) Assignee: ZEON CORPORATION, Chiyoda-ku, Tokyo (JP)

(21) Appl. No.: 14/892,290

(22) PCT Filed: May 22, 2014
(86) PCT No.: PCT/JP2014/002700

§ 371 Date: Nov. 19, 2015

(30) Foreign Application Priority Data
May 23, 2013 (JP) 2013-109381
May 23, 2013 (JP) 2013-109382

(51) Int. Cl. H01M 4/62; H01M 4/583; C08L 53/02; H01M 10/0525; H01M 4/133

(52) U.S. Cl. CPC H01M 4/622; H01M 10/0525; H01M 4/133; C08L 53/02; H01M 4/583; H01M 2004/027

(57) ABSTRACT

Provided is a secondary-battery binder composition that demonstrates superior binding capacity and can improve the electrical characteristics of secondary batteries when used to form the battery members. The disclosed binder composition contains a water-soluble thickener (A) having a hydroxy group or a carboxyl group; a cross-linking agent (B) having a carbodiimide group or an oxazoline group; and a particulate polymer (C). The particulate polymer (C) has a functional group reactive with the cross-linking agent (B), and contains an aliphatic conjugated diene monomer unit and an aromatic vinyl monomer unit. The binder composition contains 0.001 mass parts or more but less than 100 mass parts of the cross-linking agent (B) and 10 mass parts or more but less than 500 mass parts of the particulate polymer (C) per 100 mass parts of the water-soluble thickener (A).

### TECHNICAL FIELD

The disclosure relates to a secondary-battery binder composition, a slurry composition for secondary-battery electrode, a secondary-battery negative electrode, and a secondary battery.

### BACKGROUND

Secondary batteries, such as lithium ion secondary batteries, are small and light, high in energy density, and rechargeable. For such characteristics, secondary batteries are used in a wide variety of applications. Thus, battery members, such as electrodes, are studied and improved these days to further enhance the performance of the secondary batteries.

Battery members, such as electrodes (positive and negative electrodes) of secondary batteries and a porous membrane provided on the electrodes or on a separator to enhance heat resistance or strength, are formed by binding the components contained in these battery members to one another or by binding such components to a substrate (e.g., current collector, electrode, separator, etc.) using a binder. Specifically, for example, the negative electrode of a secondary battery usually includes a current collector and a negative-electrode mixed material layer formed on the current collector. The negative-electrode mixed material layer is formed for example by applying, onto the current collector, a slurry composition for electrode obtained by dispersing, for example, a negative electrode active material and a binder composition containing particulate polymers into a dispersing medium, and then drying the applied slurry composition to bind the negative electrode active material and the like using the particulate polymer.

In order to further improve the performance of the secondary battery, attempts are being made these days to provide an improved binder composition and slurry composition for electrode used to form the battery members.

For example, one specific proposal is to blend a cross-linking agent into a binder composition or a slurry composition for electrode used to form the electrodes of a secondary battery. By forming the electrodes with such a binder composition or a slurry composition for electrode, the performance of the secondary battery can be improved. For example, JP 2000-106189 A (PTL 1) proposes a secondary battery having a negative electrode comprising a mixed agent composed of a negative electrode active material, a binding agent, a thickener such as carboxymethyl cellulose, and a cross-linking agent, which is at least one agent selected from the group consisting of melamine resin, ureaformalin resin, tannic acid, glyoxal resin, di-methylol compound, and PVA. PTL 1 further discloses, for example, that the moieties of the carboxymethyl cellulose (thickener) are crosslinked to one another via the cross-linking agent.

Further, for example, JP 2011-134618 A (PTL 2) proposes a binder composition for secondary battery electrode, which contains functional group-containing resin fine particles, that is obtained by emulsion polymerizing an ethylenically unsaturated monomer containing a keto group-containing ethylenically unsaturated monomer; and a multifunctional hydrazide compound as a cross-linking agent. PTL 2 further discloses that the functional group-containing resin fine particles are crosslinked to one another via the multifunctional hydrazide compound.

Still further, for example, JP H11-288741 A (PTL 3) proposes a lithium ion secondary battery having a porous membrane on at least one of the positive electrode or negative electrode. The positive electrode or negative electrode is formed with a binding agent containing a water-soluble polymer material having a hydroxy group and a cross-linking agent having a functional group reactive with the hydroxy group. PTL 3 further discloses that the moieties of the water-soluble polymer material are crosslinked to one another via the cross-linking agent.

Still further, for example, WO 2010/114119 A (PTL 4) proposes a binder composition for non-aqueous secondary battery electrode, which contains functional group-containing crosslinked resin microparticles obtained by copolymerizing monomers containing an ethylenically unsaturated monomer having a specific functional group. PTL 4 further discloses that a compound having at least one functional group selected from an epoxy group, an amide group, a hydroxy group, and an oxazoline group is crosslinked with the functional group-containing crosslinked resin microparticles via a cross-linking agent.

### CITATION LIST

### Patent Literature

PTL 1: JP 2000-106189 A

PTL 2: JP 2011-134618 A

PTL 3: JP H11-288741 A

PTL 4: WO 2010/114119 A

### SUMMARY

### Technical Problem

The binder composition used to form aforementioned battery members would be desirable if it demonstrates good binding capacity and if a secondary battery including the battery members formed with the binder composition demonstrates good electrical characteristics (e.g., cycle characteristics).

However, the aforementioned conventional binder composition is incapable of concurrently providing sufficiently high level of binding capacity and good electrical characteristics to the secondary battery formed with the binder composition. Thus, the conventional binder composition has room for improvement in binding capacity and the electrical characteristics of the secondary battery formed with the binder composition.

It is therefore an object of the disclosure to provide a secondary-battery binder composition that demonstrates superior binding capacity and can improve the electrical characteristics of the secondary battery that includes battery members formed with the binder composition. It is another object of the disclosure to provide a slurry composition for secondary-battery electrode that enables formation of an electrode mixed material layer that demonstrates superior adherence to a current collector and can improve the electrical characteristics of the secondary battery.

It is still another object of the disclosure to provide a secondary-battery negative electrode with superior adherence between a current collector and a negative-electrode mixed material layer that can improve the electrical characteristics of a secondary battery.

It is still another object of the disclosure to provide a secondary battery with superior adherence between a current collector and a negative-electrode mixed material layer and with superior electric characteristics.

### Solution to Problem

As a result of extensive studies made to achieve the above objects, the disclosure newly discovered that the binder composition described below demonstrates superior binding capacity and can improve the electrical characteristics of a secondary battery when used to form battery members, and the products were made as disclosed herein. Such a binder composition contains a water-soluble thickener (A) having a hydroxy group or a carboxyl group, a cross-linking agent (B) having a carbodiimide group or an oxazoline group, and a particulate polymer (C) having a functional group reactive with the cross-linking agent (B) and a specific main chain structure, wherein the blending ratio of each of the cross-linking agent (B) and the particulate polymer (C) to the water-soluble thickener (A) is within a specific range.

Specifically, the disclosure is intended to advantageously solve the aforementioned problem. The secondary-battery binder composition of the disclosure contains a water-soluble thickener (A) having a hydroxy group or a carboxyl group, a cross-linking agent (B) having a carbodiimide group or an oxazoline group, and a particulate polymer (C). The particulate polymer (C) has a functional group reactive with the cross-linking agent (B), and contains an aliphatic conjugated diene monomer unit and an aromatic vinyl monomer unit. The binder composition contains 0.001 mass parts or more but less than 100 mass parts of the cross-linking agent (B) and 10 mass parts or more but less than 500 mass parts of the particulate polymer (C) per 100 mass parts of the water-soluble thickener (A). As above, by blending the water-soluble thickener (A) having a hydroxy group or a carboxyl group, the cross-linking agent (B) having a carbodiimide group or an oxazoline group, and the particulate polymer (C) having a functional group reactive with the cross-linking agent (B) and a specific main chain structure, wherein the blending ratio of the cross-linking agent (B) and the particulate polymer (C) to the water-soluble thickener (A) is within a specific range, a binder composition that demonstrates superior binding capacity and can improve electrical characteristics of the secondary battery when used to form battery members is obtained.

In this regard, the water-soluble thickener (A) contained in the secondary-battery binder composition of the disclosure is preferably at least one selected from the group consisting of: carboxymethyl cellulose, methyl cellulose, hydroxypropyl methylcellulose, hydroxyethyl methylcellulose, polyvinyl alcohol, polycarboxilic acid, and salts thereof. When the water-soluble thickener (A) is at least one selected from the above group, the slurry composition containing the binder composition can be applied onto a substrate, such as a current collector, with good workability.

The functional group in the particulate polymer (C) reactive with the cross-linking agent (B), contained in the secondary-battery binder composition of the disclosure, is preferably at least one group selected from the group consisting of a carboxyl group, a hydroxy group, a glycidyl ether group, and a thiol group. When the functional group in the particulate polymer (C) reactive with the cross-linking agent (B) is at least one group selected from the above group, the secondary battery obtained with the binder composition can demonstrate good electrical characteristics such as cycle characteristics.

Again, the disclosure is intended to advantageously solve the aforementioned problem. The slurry composition for secondary-battery electrode of the disclosure contains a water-soluble thickener (A) having a hydroxy group or a carboxyl group, a cross-linking agent (B) having a carbodiimide group or an oxazoline group, a particulate polymer (C), an electrode active material, and water. The particulate polymer (C) has a functional group reactive with the cross-linking agent (B), and contains an aliphatic conjugated diene monomer unit and an aromatic vinyl monomer unit. The slurry composition contains 0.001 mass parts or more but less than 100 mass parts of the cross-linking agent (B) and 10 mass parts or more but less than 500 mass parts of the particulate polymer (C) per 100 mass parts of the water-soluble thickener (A). As above, by blending the water-soluble thickener (A) having a hydroxy group or a carboxyl group, the cross-linking agent (B) having a carbodiimide group or an oxazoline group, and the particulate polymer (C) having a functional group reactive with the cross-linking agent (B) and a specific main chain structure, wherein the blending ratio of the cross-linking agent (B) and the particulate polymer (C) to the water-soluble thickener (A) is within a specific range, a slurry composition for secondary-battery electrode that allows formation of an electrode mixed material layer that demonstrates superior adherence to a current collector and can improve the electrical characteristic of the secondary battery can be obtained.

Again, the disclosure is intended to advantageously solve the aforementioned problem. The secondary-battery negative electrode of the disclosure has a negative-electrode mixed material layer obtained from the slurry composition for secondary-battery electrode wherein the electrode active material is a negative electrode active material. As above, by forming a negative-electrode mixed material layer on the current collector with the aforementioned slurry composition for secondary-battery electrode, a secondary-battery negative electrode with superior adherence between a current collector and a negative-electrode mixed material layer that can improve the electrical characteristics of a secondary battery can be obtained.

In this regard, the negative-electrode mixed material layer preferably has crosslinked structures formed with the water-soluble thickener (A), the cross-linking agent (B), and the particulate polymer (C). Specifically, the cross-linking agent (B) forms suitable crosslinked structures in the water-soluble thickener (A), between the water-soluble thickener (A) and the particulate polymer (C), and in the particulate polymer (C). The crosslinked structures can sufficiently improve the adherence between the current collector and the negative-electrode mixed material layer and can sufficiently improve the electrical characteristics of the secondary battery.

Again, the disclosure is intended to advantageously solve the above problem. The secondary battery of the disclosure comprises any of the aforementioned secondary-battery negative electrodes, a positive electrode, an electrolysis solution, and a separator. A secondary battery that includes the aforementioned secondary-battery negative electrode demonstrates superior electrical characteristics and excellent adherence between the current collector and the negative-electrode mixed material layer.

### Advantageous Effect

The disclosed secondary-battery binder composition can demonstrate good binding capacity and improve the electrical characteristics of the secondary battery that includes battery members formed with the binder composition. Further, the disclosed slurry composition for secondary-battery electrode enables formation of an electrode mixed material layer that demonstrates superior adherence to a current collector and can improve the electrical characteristics of the secondary battery.

Still further, the disclosed secondary-battery negative electrode can have improved adherence between the current collector and the negative-electrode mixed material layer and can improve the electrical characteristics of the secondary battery.

Moreover, the disclosed secondary battery can exhibit improved electrical characteristics and have ensured adherence between the negative-electrode mixed material layer and the current collector.

### DETAILED DESCRIPTION

In the following, embodiments of the disclosure will be described in detail.

The secondary-battery binder composition of the disclosure can be used for battery members of a secondary battery, such as a positive electrode, a negative electrode, and a porous membrane provided on the positive electrode, negative electrode, or a separator, among which the disclosed secondary-battery binder composition is suitably used to form a negative electrode. The slurry composition for secondary battery electrode of the disclosure contains the disclosed secondary-battery binder composition, and is used to form a positive electrode or a negative electrode of a secondary battery, suitably to form a negative electrode of a secondary battery. Further, the secondary-battery negative electrode of the disclosure can be produced with the disclosed slurry composition for secondary battery electrode. Still further, the secondary battery of the disclosure includes the disclosed secondary-battery negative electrode.

(Secondary-Battery Binder Composition)

The secondary-battery binder composition of the disclosure contains a water-soluble thickener (A) having a hydroxy group or a carboxyl group, a cross-linking agent (B) having a carbodiimide group or an oxazoline group, and a particulate polymer (C) having a functional group reactive with the cross-linking agent (B) and a specific main chain structure. The secondary-battery binder composition of the disclosure contains 0.001 mass parts or more but less than 100 mass parts of the cross-linking agent (B) and 10 mass parts or more but less than 500 mass parts of the particulate polymer (C) per 100 mass parts of the water-soluble thickener (A). According to the disclosed secondary-battery binder composition, good binding capacity can be obtained and the electrical characteristics of the secondary battery that includes battery members formed with the binder composition can be improved.

In the following, each component contained in the binder composition will be described with reference to an example in which the binder composition is used particularly to form a negative electrode.

<Water-Soluble Thickener (A)>

The water-soluble thickener (A) having a hydroxy group or a carboxyl group (hereinafter frequently abbreviated as “water-soluble thickener (A)”) functions as a viscosity modifier in the binder composition and the slurry composition containing the binder composition. The water-soluble thickener (A) having a hydroxy group or a carboxyl group may be any compound that has at least one of a hydroxy group or a carboxyl group in its molecular structure and can be used as a water-soluble thickener.

In this specification, a thickener that satisfies the following condition can be defined as “water-soluble”: when a mixture obtained by adding and stirring 1 mass part of thickener (in terms of solid content) into 100 mass parts of deionized water is adjusted to satisfy both of the conditions that the temperature is within a range of 20° C. to 70° C. and the pH is within a range of 3 to 12 (for pH adjustment, NaOH solution and/or HCl solution is used) and is filtered through a 250 mesh screen, the mass of the residual solid content left on the screen without passing through the screen does not exceed 50 mass % of the solid content of the thickener that has been added. Even if the above mixture of the thickener and water when left still exhibits emulsion state with separated two phases, the thickener can be identified as water-soluble as long as it satisfies above definition.

Examples usable as the water-soluble thickener (A) include carboxymethyl cellulose, methyl cellulose, hydroxypropyl methylcellulose, hydroxyethyl methylcellulose, polyvinyl alcohol, polycarboxilic acid, and salts thereof, which may provide good workability when the slurry composition containing the binder composition is applied onto a current collector or the like. Examples of the polycarboxilic acid include polyacrylic acid, polymethacrylic acid, and alginic acid. These water-soluble thickeners (A) may be used alone or in combination of two or more thereof at any ratio.

The water-soluble thickener (A) preferably contains carboxymethyl cellulose or a salt thereof (hereinafter frequently abbreviated as “carboxymethyl cellulose (salt)”). When the water-soluble thickener (A) contains carboxymethyl cellulose (salt), the slurry composition containing the binder composition can provide better workability when the slurry composition is applied onto a current collector or the like.

When carboxymethyl cellulose (salt) is used as the water-soluble thickener (A), the degree of etherification of the carboxymethyl cellulose (salt) used is preferably 0.4 or higher, more preferably 0.7 or higher, but is preferably 1.5 or lower, more preferably 1.0 or lower. With the use of carboxymethyl cellulose (salt) having an etherification degree of 0.4 or higher, the slurry composition containing the binder composition can be applied onto the current collector or the like with good workability. If the etherification degree is lower than 0.4, the strong hydrogen bonding in and between the molecules of the carboxymethyl cellulose (salt) may cause the water-soluble thickener (A) to turn into a gel-like product, possibly reducing the thickening effect of the slurry composition for secondary-battery electrode, so that the workability upon preparation of the slurry composition for secondary-battery electrode may be reduced. Further, in applying the slurry composition for secondary-battery electrode obtained onto the current collector and forming crosslinked structures via the cross-linking agent (B), carboxymethyl cellulose (salt) may become less reactive with the cross-linking agent (B), possibly deteriorating the characteristics of the electrode to be obtained. Compared to this, with the use of carboxymethyl cellulose having an etherification degree of 1.5 or lower, the number of hydroxy group per carboxymethyl cellulose (salt) molecule becomes sufficient, thus achieving good reactivity with the cross-linking agent (B), which will be described later. In this manner, carboxymethyl cellulose (salt) can form good crosslinked structures via the cross-linking agent (B), and such crosslinked structures enables the disclosed binder composition to demonstrate good binding capacity, which will be described in more detail below. In this way, superior cycle characteristics of the secondary battery can be achieved.

The etherification degree of carboxymethyl cellulose (salt) is the average number of hydroxy group substituted by a substituent such as a carboxymethyl group, per one anhydroglucose unit forming the carboxymethyl cellulose (salt). The average number may take a value of greater than 0 but less than 3. A greater etherification degree indicates a smaller proportion of the hydroxy group in one carboxymethyl cellulose (salt) molecule (i.e., indicates a greater proportion of the substituent), and a smaller etherification degree indicates a greater proportion of the hydroxy group in one carboxymethyl cellulose (salt) molecule (i.e., indicates a smaller proportion of the substituent). This etherification degree (substitution degree) can be obtained by the method described in JP2011-34962A.

The viscosity of a 1 mass % aqueous solution of the carboxymethyl cellulose (salt) is preferably 500 mPa·s or greater, more preferably 1000 mPa·s or greater, but is preferably 10000 mPa·s or less, more preferably 9000 mPa·s or less. With the use of the carboxymethyl cellulose (salt) that gives a solution viscosity of 500 mPa·s or greater when prepared as a 1 mass % aqueous solution, the viscosity of the slurry composition containing the binder composition would become moderate, so that the slurry composition can be applied onto the current collector or the like with good workability. Further, with the use of carboxymethyl cellulose (salt) that gives a solution viscosity of 10000 mPa·s or less when prepared as a 1 mass % aqueous solution, the viscosity of the slurry composition containing the binder composition would not become too high, so that the slurry composition can be applied onto the current collector or the like with good workability, and further the adherence between the negative-electrode mixed material layer obtained with the slurry composition containing the binder composition and the current collector can be improved. The viscosity of a 1 mass % aqueous solution of carboxymethyl cellulose (salt) is measured with Brookfield viscometer at 25° C. at 60 rpm.

It is further preferred that the water-soluble thickener (A) contain both of carboxymethyl cellulose (salt) and polycarboxilic acid or a salt thereof (hereinafter frequently abbreviated as “polycarboxilic acid (salt)”). By using carboxymethyl cellulose (salt) and polycarboxilic acid (salt) in combination as the water-soluble thickener (A), the binding capacity of the binder composition can be improved, so that the adherence between the negative-electrode mixed material layer obtained with the slurry composition containing the binder composition and the current collector can be improved and mechanical characteristics, such as strength, of the negative-electrode mixed material layer containing the water-soluble thickener (A) can be also improved. These effects are further followed by the improvement in cycle characteristics of the secondary battery including the above negative electrode. In this regard, the polycarboxilic acid (salt) used in combination with carboxymethyl cellulose (salt) is preferably alginic acid or a salt thereof (hereinafter frequently abbreviated as “alginic acid (salt)”), or polyacrylic acid or a salt thereof (hereinafter frequently abbreviated as “polyacrylic acid (salt)”). Polyacrylic acid (salt) is particularly preferred. In a word, a water-soluble thickener (A) containing carboxymethyl cellulose or a salt thereof and polyacrylic acid or a salt thereof is particularly preferred. This is because alginic acid and polyacrylic acid are less likely to undergo excessive swell in the electrolysis solution of the secondary battery as compared with polymethacrylic acid or the like. Thus, by using carboxymethyl cellulose (salt) in combination with alginic acid or polyacrylic acid (salt) as above, the cycle characteristics of the secondary battery can be sufficiently improved. Further, since polyacrylic acid (salt) has better reactivity with the cross-linking agent (B) than carboxymethyl cellulose (salt), use of the polyacrylic acid can promote the crosslinked structure-forming reaction via the cross-linking agent (B).

In the disclosed binder composition, when the water-soluble thickener (A) contains carboxymethyl cellulose (salt) and polycarboxilic acid (salt), the proportion of the blending amount of the polycarboxilic acid (salt), of the sum of the blending amount of the carboxymethyl cellulose (salt) and the blending amount of the polycarboxilic acid (salt), is preferably 0.1 mass % or more, more preferably 0.5 mass % or more, particularly preferably 1 mass % or more, but preferably 20 mass % or less, more preferably 10 mass % or less, particularly preferably 5 mass % or less. When the proportion of the blending amount of the polycarboxilic acid (salt), of the sum of the blending amount of the carboxymethyl cellulose (salt) and the blending amount of the polycarboxilic acid (salt), is 0.1 mass % or more, the effects possibly provided by the combined use of the carboxymethyl cellulose (salt) and the polycarboxilic acid (salt) can be sufficiently exerted. Therefore, the binding capacity of the binding composition can be desirably improved, allowing the adherence between the negative-electrode mixed material layer obtained with the slurry composition containing the binder composition and the current collector to be desirably improved. Further, when the proportion of the blending amount of the polycarboxilic acid (salt), of the sum of the blending amount of the carboxymethyl cellulose (salt) and the blending amount of the polycarboxilic acid (salt), is 20 mass % or less, the negative-electrode mixed material layer obtained with the slurry composition containing the binder composition would not become too hard, so that the binding capacity and the ion conductivity of the binder composition can be ensured. Further, the adherence between the negative-electrode mixed material layer obtained with the slurry composition containing the binder composition and the current collector can be desirably improved.

<Cross-Linking Agent (B)>

The cross-linking agent (B) having a carbodiimide group or an oxazoline group (hereinafter frequently abbreviated as “cross-linking agent (B)”) forms crosslinked structures with the aforementioned water-soluble thickener (A) having a hydroxy group or a carboxyl group and with the particulate polymer (C), which is described later, when for example they are heated. In other words, it is presumed that the cross-linking agent (B) forms suitable crosslinked structures in the water-soluble thickener (A), between the water-soluble thickener (A) and the particulate polymer (C), and in the particulate polymer (C).

Specifically, the water-soluble thickener (A) and the particulate polymer (C) contained in the disclosed binder composition or in the disclosed the slurry composition containing the binder composition form crosslinked structures via the cross-linking agent (B) when treated for example with heat. These cross-linkings in the water-soluble thickener (A), between the water-soluble thickener (A) and the particulate polymer (C), and in the particulate polymer (C) consequently provide crosslinked structures with superior mechanical characteristics, such as elastic modulus, tensile breaking strength, and fatigue resistance, and superior adhesiveness, as well as with low solubility to water (i.e., with superior water resistance). In addition, the formation of the crosslinked structures improves wettability of the battery members formed with the binder composition to the electrolysis solution of secondary battery. The reason is presumed as follows. The water-soluble thickener (A) having a hydroxy group or a carboxyl group has molecular chains that tend to tangle with one another tightly due to formation of hydrogen bonding or the like, but when the cross-linking reaction occurs, the molecules of the cross-linking agent (B) enter into the tightly-tangled water-soluble thickener (A). This loosens the molecule chains of the water-soluble thickener (A) to provide physical space into which the electrolysis solution can enter.

Therefore, when the disclosed binder composition or the disclosed slurry composition containing the binder composition is used for preparation of the negative electrode of secondary battery, the formation of the crosslinked structures can suppress the expansion of the negative electrode caused due to repeated charge and discharge, and ensure close adherence between the negative-electrode mixed material layer and the current collector. Furthermore, the water resistance (low solubility to water) obtained by the formation of the crosslinked structure may allow use of an aqueous slurry composition in forming a porous membrane (e.g., a heat resistant porous membrane formed with alumina particles) and the like on the negative-electrode mixed material layer. Moreover, the crosslinked structures derived from the cross-linking agent (B) improves wettability to the electrolysis solution. This increases the injectability of the electrolysis solution in forming the secondary battery with the battery members prepared with the disclosed binder composition or the disclosed the slurry composition containing the binder composition, thus improving output characteristics and the like. In addition, the cycle characteristics of the secondary battery can be improved and the resistance increase after cycles can be also suppressed.

When the binder composition and the slurry composition containing the binder composition do not contain the water-soluble thickener (A) having a hydroxy group or a carboxyl group; that is, when the crosslinked structures are formed only in the particulate polymers (C), no crosslinked structures would be obtained that provide sufficiently good mechanical characteristics such as elastic modulus, tensile breaking strength, and fatigue resistance, thus failing, for example, to suppress the expansion of the negative electrode. Alternatively, when the binder composition and the slurry composition containing the binder composition do not contain the particulate polymer (C), which will be described later; that is, when the crosslinked structures are formed only in the water-soluble thickener (A), the crosslinked structures obtained would become excessively rigid, lowering flexibility of the electrode formed with the disclosed secondary-battery binder composition, for example. This may lead to deterioration in cycle characteristics.

The disclosed secondary-battery binder composition needs to contain the cross-linking agent (B) in an amount of 0.001 mass parts or more, preferably 0.5 mass parts or more, more preferably 1 mass part or more, even more preferably 2 mass parts or more, particularly preferably 4 mass parts or more, and the most preferably 5 mass parts or more per 100 mass parts of the water-soluble thickener (A). The content of the cross-linking agent (B) also needs to be less than 100 mass parts, preferably 60 mass parts or less, more preferably 40 mass parts or less, even more preferably 15 mass parts or less, and particularly preferably 10 mass parts or less per 100 mass parts of the water-soluble thickener (A). When the secondary-battery binder composition contains 0.001 mass parts or more of the cross-linking agent (B) per 100 mass parts of the water-soluble thickener (A), good crosslinked structures can be formed. Thus, when the binder composition and the slurry composition containing the binder composition are used to form for example a negative electrode, close adherence between the negative-electrode mixed material layer and the current collector can be ensured, and in addition, good injectability of electrolysis solution can be achieved in producing the secondary battery including the above negative electrode. On the other hand, when the secondary-battery binder composition contains less than 100 mass parts of the cross-linking agent (B) per 100 mass parts of the water-soluble thickener (A), the crosslinked structures would not be suffered from unevenness so that close adherence between the negative-electrode mixed material layer and the current collector can be ensured. In addition, the presence of a large amount of (relatively flexible) cross-linking agent (B) would suppress reduction in strength of the negative-electrode mixed material layer. Further, prevention of charge carrier migration in the negative-electrode mixed material layer, which could be caused due to excessive cross-linking, can be also suppressed. Still further, electrochemical side reactions which could be caused due to cross-linking agent-derived impurities can be also suppressed.

Consequently, with the secondary-battery binder composition containing the cross-linking agent in the above range per 100 mass parts of the water-soluble thickener (A), the cycle characteristics of the secondary battery can be ensured and an increase in resistance after cycles can be suppressed.

[Structure of Cross-Linking Agent (B) with Carbodiimide Group or Oxazoline Group]

The cross-linking agent (B) may be any cross-linking compound that has at least one of carbodiimide group represented by the general formula (1): —N═C═N— (1) or oxazoline group and can form crosslinked structures in the water-soluble thickener (A), between the water-soluble thickener (A) and the particulate polymer (C), and in the particulate polymer (C).

Examples of the cross-linking agent (B) include carbodiimide compounds having a carbodiimide group as a crosslinkable group and oxazoline compounds having an oxazoline group as a crosslinkable group. Of the cross-linking agents (B), carbodiimide compounds are preferred. Carbodiimide compounds, which have superior heat stability, would rarely be lost when reacted with water for example in preparation of the binder composition or the slurry composition. In particular, even when used in a small amount, the carbodiimide compounds used as the cross-linking agent (B) can sufficiently increase the adherence between the negative-electrode mixed material layer obtained and the current collector to ensure the electrical characteristics of the secondary battery. Further, the use of the carbodiimide compounds can also increase the water resistance of the negative electrode.

In the following, carbodiimide compounds and oxazoline compounds will be described in detail.

[[Carbodiimide Compound]]

Examples of the carbodiimide compound used as the cross-linking agent (B) include compounds having two or more carbodiimide groups in the molecules. One specific suitable example of the carbodiimide compound is polycarbodiimide having repeat units represented by the general formula (2): —N═C═N—R¹ (2) (where R¹ indicates a divalent organic group) and/or modified polycarbodiimide. The modified polycarbodiimide herein refers to resin obtained by reacting a reactive compound, which will be described later, with polycarbodiimide.

—Synthesis of Polycarbodiimide—

Polycarbodiimide can be synthesized by any method. For example, polycarbodiimide can be synthesized by reacting organic polyisocyanate in the presence of a catalyst that promotes carbodiimidization reaction of the isocyanate group (hereinafter referred to as “carbodiimidization catalyst”). The polycarbodiimide having the repeat unit represented by the general formula (2) can also be synthesized by copolymerizing an oligomer obtained by reacting the organic polyisocyanate (carbodiimide oligomer) with a monomer copolymerizable with the oligomer.

A preferred organic polyisocyanate used for the synthesis of the polycarbodiimide is organic diisocyanate.

Examples of the organic diisocyanate used for the synthesis of the polycarbodiimide include those described in JP2005-49370A. Of these, 2,4-tolylene diisocyanate and 2,6-tolylene diisocyanate are preferred, considering the preservation stability of the binder composition and the slurry composition containing polycarbodiimide as the cross-linking agent (B). The organic diisocyanate may be used alone or in combination of two or more thereof at any ratio.

Together with the aforementioned organic diisocyanate, an organic polyisocyanate having three or more isocyanate groups (tri- or more functional organic polyisocyanate) or a terminal isocyanate prepolymer obtained by the reaction of stoichiometric excessive amounts of tri- or more functional organic polyisocyanate with a multifunctional active hydrogen-containing compound having di- or more functionalities may be used. Hereinafter, the tri- or more functional organic polyisocyanate and the terminal isocyanate prepolymer are collectively referred to as “tri- or more functional organic polyisocyanates”. Examples of such tri- or more functional organic polyisocyanates include those described for example in JP2005-49370A. The tri- or more functional organic polyisocyanates may be used alone or in combination of two or more thereof at any ratio. The amount of the tri- or more functional organic polyisocyanates used in the synthesis reaction of polycarbodiimide is usually 40 mass parts or less, preferably 20 mass parts or less per 100 mass parts of the organic diisocyanate.

Further, in synthesizing polycarbodiimide, organic monoisocyanate may be added as necessary. By adding organic monoisocyanate, when the organic polyisocyanate contains tri- or more functional organic polyisocyanates, the molecular weight of the polycarbodiimide obtained can be regulated appropriately. Further, by using organic diisocyanate in combination with organic monoisocyanate, the polycarbodiimide obtained will have relatively low molecular weight. Examples of such organic monoisocyanate include those described in JP2005-49370A. The organic monoisocyanate may be used alone or in combination of two or more thereof at any ratio. The amount of the organic monoisocyanate used in the synthesis reaction of polycarbodiimide is usually 40 mass parts or less, preferably 20 mass parts or less, per 100 mass parts of the total organic polyisocyanate component (organic diisocyanate and tri- or more organic polyisocyanates), although the amount changes depending for example on the molecular weight required for the polycarbodiimide to be obtained and whether any tri- or more organic polyisocyanates are used.

Examples of the carbodiimidization catalyst include phospholene compounds, metal carbonyl complexes, metal acetylacetone complexes, and phosphoric acid ester. Specific examples of each of them are shown for example in JP2005-49370A. The carbodiimidization catalyst may be used alone or in combination of two or more thereof at any ratio. The amount of the carbodiimidization catalyst used is usually 0.001 mass parts or more, preferably 0.01 mass parts or more, but usually 30 mass parts or less, preferably 10 mass parts or less, per 100 mass parts of the total organic isocyanate component (organic isocyanate, organic diisocyanate, and tri- or more organic polyisocyanates).

The carbodiimidization reaction of the organic polyisocyanate can be carried out without solvent or in a suitable solvent. If the synthesis reaction is carried out in a solvent, any solvent that can dissolve the polycarbodiimide or the carbodiimide oligomer to be formed through heating during the synthesis reaction can be used. Examples of such solvent include halogenated hydrocarbon solvents, ether solvents, ketone solvents, aromatic hydrocarbon solvents, amide solvents, aprotic polar solvents, and acetate solvents. Specific examples of each of them are shown for example in JP2005-49370A. These solvents may be used alone or in combination of two or more thereof at any ratio. The amount of the solvent used in the synthesis reaction of polycarbodiimide is such an amount that allows the concentration of the total organic isocyanate component to become usually 0.5 mass % or higher, preferably 5 mass % or higher, but usually 60 mass % or lower, preferably 50 mass % or lower. If the concentration of the total organic isocyanate component in the solvent is too high, the polycarbodiimide or the carbodiimide oligomer to be formed may gelate during the synthesis reaction. If the concentration of the total organic isocyanate component in the solvent is too low, the reaction rate is decreased and productivity is declined.

The temperature at which the carbodiimidization reaction of the organic polyisocyanate occurs is appropriately selected depending on the organic isocyanate component and the kind of the carbodiimidization catalyst. However, the temperature is usually 20° C. or higher but 200° C. or lower. In the carbodiimidization reaction of the organic polyisocyanate, the totality of the organic isocyanate component may be added before the reaction. Alternatively, part or the totality of the organic isocyanate component may be added during the reaction continuously or stepwise. Further, a compound reactive with an isocyanate group may be added at any suitable reaction stage from the initial stage to later stage of the carbodiimidization of the organic polyisocyanate to seal the terminal isocyanate group of the polycarbodiimide, which allows adjustment of the molecular weight of the polycarbodiimide to be obtained. Alternatively, the compound may be added at a later stage of the carbodiimidization reaction of the organic polyisocyanate to regulate the molecular weight of the polycarbodiimide to be obtained to a predetermined value. Examples of the compound reactive with such an isocyanate group include alcohols such as methanol, ethanol, i-propanol, and cyclohexanol; and amines such as dimethylamine, diethylamine, and benzylamine.

Preferred examples of the monomer copolymerizable with the carbodiimide oligomer include di- or more valent alcohol, and an oligomer obtained by using di- or more valent alcohol as a monomer and esters thereof. Preferred examples of the di- or more valent alcohol include divalent alcohols such as ethylene glycol and propylene glycol; and preferred examples of the oligomer obtained by using di- or more valent alcohol as a monomer and esters thereof includes polyalkylene oxide, polyethylene glycol monomethacrylate, polypropylene glycol monomethacrylate, polyethylene glycol monoacrylate, and polypropylene glycol monoacrylate.

For example, by copolymerizing divalent alcohol having a hydroxyl group at each terminal of the molecular chain and the carbodiimide oligomer using a conventional method, a polycarbodiimide having a polycarbodiimide group and a divalent alcohol-derived monomer unit can be synthesized. As above, when the polycarbodiimide as the cross-linking agent (B) has a di- or more valent alcohol-derived monomer unit, preferably a divalent alcohol-derived monomer unit, the wettability of the battery members (such as a negative electrode) formed from the binder composition containing the polycarbodiimide to the electrolysis solution can be improved, so that the injectability of the electrolysis solution can be improved in producing the secondary battery including the battery member. Further, by copolymerizing the aforementioned alcohols, the water solubility of the polycarbodiimide can be increased and the polycarbodiimide self-assembles into micelles in water (or the hydrophobic carbodiimide group is covered around with hydrophile ethylene glycol chains), which can thus improve chemical stability.

The aforementioned polycarbodiimide is used in preparation of the disclosed binder composition or slurry composition in the form of solution or in the form of solid separated from the solution. The polycarbodiimide may be separated and collected from the solution for example by adding the polycarbodiimide solution to a non-solvent inactive to the polycarbodiimide, and filtering or decanting the resulting precipitation or oil matter; by spray drying the polycarbodiimide solution; or by utilizing the temperature-caused solubility change with respect to the solvent used in the synthesis of the polycarbodiimide, that is, by decreasing the temperature of the system to precipitate the polycarbodiimide, which had been dissolved in the solvent immediately after the synthesis, and for example filtering the turbid solution. These separation collection methods may also be used in any combination. The number-average molecular weight (hereinafter referred to as “Mn”) of the disclosed polycarbodiimide in terms of polystyrene obtained by gel permeation chromatography (GPC) is usually 400 or more, preferably 1,000 or more, particularly preferably 2,000 or more, but usually 500,000 or less, preferably 200,000 or less, particularly preferably 100,000 or less.

—Synthesis of Modified Polycarbodiimide—

Next, a method of synthesizing the modified polycarbodiimide is described. The modified polycarbodiimide can be synthesized by reacting at least one reactive compound with at least one polycarbodiimide having the repeat unit represented by the general formula (2) in the presence or absence of a suitable catalyst at a suitable temperature (hereinafter referred to as “modification reaction”).

The reactive compound used in the synthesis of the modified polycarbodiimide is a compound having one group reactive with polycarbodiimide (hereinafter simply referred to as “reactive group”) and other functional groups in its molecule. The reactive compound may be an aromatic compound, an aliphatic compound, or an alicyclic compound. The ring structure of the aromatic compound and the alicyclic compound may be carbocyclic or heterocyclic. The reactive group in the reactive compound can be any group that has active hydrogen, such as a carboxyl group, and a primary or secondary amino group. As mentioned, the reactive compound has other functional groups in addition to the one reactive group in its molecule. Such other functional groups in the reactive compound may be, for example, groups that function to promote cross-linking reaction of polycarbodiimide and/or modified polycarbodiimide, or second and subsequent groups (i.e., different groups from the aforementioned one reactive group), in one molecule of the reactive compound, having the aforementioned active hydrogen, such as the carboxyl group and the primary or secondary amino group mentioned above as the group having active hydrogen, as well as a carboxylic acid anhydride group and a tertiary amino group. Two or more identical or different other functional groups can exist in one molecule of the reactive compound.

Examples of the reactive compound include those described in JP2005-49370A. Of the reactive compounds, trimellitic anhydride and nicotinic acid are preferred. The reactive compounds may be used alone or in combination of two or more thereof at any ratio.

The amount of the reactive compound used in the modification reaction for synthesizing the modified polycarbodiimide is appropriately adjusted according to the kind of the polycarbodiimide and the reactive compound as well as the physical properties or the like required for the modified polycarbodiimide obtained. However, the amount is adjusted such that the proportion of the reactive group in the reactive compound relative to 1 mole of the repeat unit represented by the general formula (2) of polycarbodiimide becomes preferably 0.01 moles or more, further preferably 0.02 moles or more, but preferably 1 mole or less, further preferably 0.8 moles or less. When the above proportion is less than 0.01 moles, the preservation stability of the binder composition or the slurry composition containing the modified polycarbodiimide may be decreased. Conversely, if the above proportion exceeds 1 mole, the intrinsic properties of polycarbodiimide may be impaired.

In the modification reaction, reaction of the reactive group in the reactive compound with the repeat unit represented by the general formula (2) of polycarbodiimide proceeds quantitatively, and functional groups that correspond to the used amount of the reactive compound are introduced into the modified polycarbodiimide. The modification reaction can be carried out without any solvent; however, it is preferably carried out in an appropriate solvent. Such a solvent may be any solvent that is inactive to polycarbodiimide and the reactive compound and can dissolve them. Examples of the solvent include ether solvents, amide solvents, ketone solvents, aromatic hydrocarbon solvents, and aprotic polar solvent usable in the aforementioned synthesis of the polycarbodiimide. These solvents may be used alone or in combination of two or more thereof at any ratio. When the solvent used in the synthesis of the polycarbodiimide can be used for the modified reaction, the polycarbodiimide solution obtained by the synthesis can be directly used. The amount of the solvent used in the modification reaction is usually 10 mass parts or more, preferably 50 mass parts or more, but usually 10,000 mass parts or less, preferably 5,000 mass parts of less, per 100 mass parts of the total reaction material. The temperature of the modification reaction is appropriately selected depending on the kind of the polycarbodiimide and the reactive compound; however, it is usually −10° C. or higher, but usually 100° C. or lower, preferably 80° C. or lower. Mn of the disclosed modified polycarbodiimide is usually 500 or more, preferably 1,000 or more, further preferably 2,000 or more, but usually 1,000,000 or less, preferably 400,000 or less, further preferably 200,000 or less.

—NCN Equivalent—

The chemical formula weight of the carbodiimide compound used as the cross-linking agent (B) per mole of the carbodiimide group (—N═C═N—) (NCN equivalent) is preferably 300 or more, more preferably 400 or more, but preferably 600 or less, more preferably 500 or less. With the NCN equivalent of the carbodiimide compound being 300 or more, the preservation stability of the disclosed binder composition and slurry composition can be sufficiently ensured. With that being 600 or less, the carbodiimide compound can promote good cross-linking reaction as a cross-linking agent.

In this regard, the NCN equivalent of the carbodiimide compound can be calculated for example with the formula below by obtaining the polystyrene-converted number-average molecular weight of the carbodiimide compound using GPC (gel permeation chromatography) and by performing quantitative analysis of the number of the carbodiimide group per mole of the carbodiimide compound using IR (infrared spectroscopy).

NCN equivalent=(polystyrene-converted number-average molecular weight of carbodiimide compound)/(number of carbodiimide group per molecule of carbodiimide compound)

[[Oxazoline Compound]]

Suitable examples of the oxazoline compound used as the cross-linking agent (B) include compounds having two or more oxazoline groups in the molecule. Some or all of the hydrogen atoms of the oxazoline group may be substituted with other groups. Examples of such a compound having two or more oxazoline groups in the molecule include a compound having two oxazoline groups in the molecule (divalent oxazoline compound) and a polymer containing an oxazoline group (oxazoline group-containing polymer).

—Divalent Oxazoline Compound—

Examples of the divalent oxazoline compound include 2,2′-bis(2-oxazoline), 2,2′-bis(4-methyl-2-oxazoline), 2,2′-bis(4,4-dimethyl-2-oxazoline), 2,2′-bis(4-ethyl-2-oxazoline), 2,2′-bis(4,4′-diethyl-2-oxazoline), 2,2′-bis(4-propyl-2-oxazoline), 2,2′-bis(4-butyl-2-oxazoline), 2,2′-bis(4-hexyl-2-oxazoline), 2,2′-bis(4-phenyl-2-oxazoline), 2,2′-bis(4-cyclohexyl-2-oxazoline), 2,2′-bis(4-benzyl-2-oxazoline). Of these, 2,2′-bis(2-oxazoline) is preferred to form a more rigid crosslinked structure.

—Oxazoline Group-Containing Polymer—

The oxazoline group-containing polymer may be any polymer that contains an oxazoline group. In this specification, the aforementioned divalent oxazoline compounds are not included in the oxazoline group-containing polymer.

The oxazoline group-containing polymer can be synthesized for example by copolymerizing the oxazoline group-containing monomer represented by the following general formula (3) and another monomer.

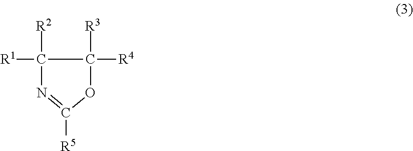

(In the formula, R¹, R², R³, and R⁴ each independently represent a hydrogen atom, a halogen atom, an alkyl group, an aryl group optionally having a substituent, or an aralkyl group optionally having a substituent, and R⁵ represents an acyclic organic group having an addition-polymerizable unsaturated bond.)

The halogen atom in the general formula (3) may be, for example, a fluorine atom, a chlorine atom, a bromine atom, or an iodine atom. Of these, the fluorine atom and the chlorine atom are preferred.

The alkyl group in the general formula (3) may be, for example, an alkyl group having a carbon number of 1 to 8. Of these, an alkyl group having a carbon number of 1 to 4 is preferred.

The aryl group optionally having a substituent in the general formula (3) is, for example, an aryl group optionally having a substituent such as a halogen atom. The aryl group may be, for example, an aryl group having a carbon number of 6 to 18, such as a phenyl group, a tolyl group, a xylyl group, a biphenyl group, a naphthyl group, an anthryl group, and a phenanthryl group. A preferred aryl group optionally having a substituent is an aryl group having a carbon number of 6 to 12 and optionally having a substituent.

The aralkyl group optionally having a substituent in the general formula (3) may be, for example, an aralkyl group optionally having a substituent such as a halogen atom. The aralkyl group may be, for example, an aralkyl group having a carbon number of 7 to 18, such as a benzyl group, a phenylethyl group, a methylbenzyl group, and a naphthylmethyl group. A preferred aralkyl group optionally having a substituent is an aralkyl group having a carbon number of 7 to 12 and optionally having a substituent.

The acyclic organic group having an addition-polymerizable unsaturated bond in the general formula (3) may be, for example, an alkenyl group having a carbon number of 2 to 8, such as a vinyl group, an allyl group, and an isopropenyl group. Of these, a vinyl group, an allyl group, and an isopropenyl group are preferred.

Examples of the oxazoline group-containing monomer represented by the general formula (3) include 2-vinyl-2-oxazoline, 2-vinyl-4-methyl-2-oxazoline, 2-vinyl-4-ethyl-2-oxazoline, 2-vinyl-4-propyl-2-oxazoline, 2-vinyl-4-butyl-2-oxazoline, 2-vinyl-5-methyl-2-oxazoline, 2-vinyl-5-ethyl-2-oxazoline, 2-vinyl-5-propyl-2-oxazoline, 2-vinyl-5-butyl-2-oxazoline, 2-isopropenyl-2-oxazoline, 2-isopropenyl-4-methyl-2-oxazoline, 2-isopropenyl-4-ethyl-2-oxazoline, 2-isopropenyl-4-propyl-2-oxazoline, 2-isopropenyl-4-butyl-2-oxazoline, 2-isopropenyl-5-methyl-2-oxazoline, 2-isopropenyl-5-ethyl-2-oxazoline, 2-isopropenyl-5-propyl-2-oxazoline, and 2-isopropenyl-5-butyl-2-oxazoline. Of these, 2-isopropenyl-2-oxazoline is preferred for its industrially ready availability. These oxazoline group-containing monomers may be used alone or in combination of two or more thereof at any ratio.

The aforementioned another monomer that may be used for the synthesis of the oxazoline group-containing polymer may be any copolymerizable monomer known in the art. Suitable examples thereof include a (meth)acrylic acid monomer, a (meth)acrylic acid ester monomer, and an aromatic monomer. The term “(meth)acrylic” as used herein means “acrylic” and/or “methacrylic”.

Examples of the (meth)acrylic acid monomer usable for the synthesis of the oxazoline group-containing polymer include acrylic acid, methacrylic acid, acrylate such as sodium acrylic acid and ammonium acrylic acid, and methacrylate such as sodium methacrylic acid and ammonium methacrylic acid. These (meth)acrylic acid monomers may be used alone or in combination of two or more thereof at any ratio.

Examples of the (meth)acrylic acid ester monomer usable for the synthesis of the oxazoline group-containing polymer include acrylic acid esters, such as methyl acrylate, ethyl acrylate, butyl acrylate, 2-ethylhexyl acrylate, stearyl acrylate, perfluoroalkylethyl acrylate, phenyl acrylate, 2-hydroxyethyl acrylate, 2-aminoethyl acrylate and its salt, acrylic acid methoxy polyethylene glycol, and a monoesterified product of acrylic acid and polyethylene glycol; and methacrylic acid esters, such as methyl methacrylate, butyl methacrylate, 2-ethylhexyl methacrylate, 2-hydroxyethyl methacrylate, methoxy polyethylene glycol methacrylate, monoesterified product of methacrylic acid and polyethylene glycol, and 2-aminoethyl methacrylate and its salt. These (meth)acrylic acid ester monomers may be used alone or in combination of two or more thereof at any ratio.

Examples of the aromatic monomer usable for the synthesis of the oxazoline group-containing polymer include styrene compounds, such as styrene, α-methyl styrene, and sodium styrenesulfonate. These aromatic monomers may be used alone or in combination of two or more thereof at any ratio.

By polymerizing these monomers using them at the ratio described for example in JP2013-72002A or Japanese Patent No. 2644161 and using the method described in these documents, oxazoline group-containing polymer can be synthesized. Alternatively, the oxazoline group-containing polymer may be synthesized for example by polymerizing polymers without any oxazoline group, and then substituting oxazoline groups for some or all of the functional groups of the polymer.

The glass-transition temperature (Tg) of the oxazoline group-containing polymer is preferably −50° C. or higher, more preferably −20° C. or higher, and preferably 60° C. or lower, more preferably 30° C. or lower.

The glass-transition temperature of the oxazoline group-containing polymer can be measured in accordance with the method used for the particulate polymer (C) described in the example section of the specification.

—Oxazoline Equivalent—

The chemical formula weight of the oxazoline compound used as the cross-linking agent (B) per mole of the oxazoline group (oxazoline equivalent) is preferably 70 or more, more preferably 100 or more, further preferably 300 or more, but preferably 600 or less, more preferably 500 or less. This oxazoline equivalent may also be called an oxazoline valence (mass per mole of oxazoline group (g-solid/eq.)). With the oxazoline equivalent of the oxazoline compound being 70 or more, the preservation stability of the disclosed binder composition and the slurry composition can be sufficiently ensured. With that 600 or less, the oxazoline compound can promote good cross-linking reaction as a cross-linking agent.

The oxazoline equivalent of the oxazoline compound can be calculated with the following formula:

Oxazoline equivalent=(molecular weight of oxazoline compound)/(number of oxazoline group per molecule of oxazoline compound)

In this regard, when the oxazoline compound is the oxazoline group-containing polymer, the molecular weight of the oxazoline compound can be specified, for example, as a polystyrene-converted number-average molecular weight measured with GPC (gel permeation chromatography), and the number of the oxazoline group per molecule of oxazoline compound can be quantified for example with IR (infrared spectroscopy).

[[Physical Properties of Cross-Linking Agent (B)]]

The viscosity of a 1 mass % aqueous solution of the cross-linking agent (B) is preferably 5000 mPa·s or lower, more preferably 700 mPa·s or lower, and particularly preferably 150 mPa·s or lower. By using the cross-linking agent that gives a solution viscosity within the above range when prepared as a 1 mass % aqueous solution, superior adherence between the negative-electrode mixed material layer and the current collector can be achieved. The viscosity of a 1 mass % aqueous solution of the cross-linking agent (B) can be measured with the same method as that used for measuring the viscosity of the 1 mass % aqueous solution of the aforementioned carboxymethyl cellulose (salt).

The cross-linking agent (B) is preferably water-soluble. Being water-soluble, the cross-linking agent (B) can be prevented from unevenly distributed in the aqueous slurry composition containing the binder composition, so that the negative-electrode mixed material layer obtained can form a suitable crosslinked structure. This can accordingly ensure the adherence strength between the negative-electrode mixed material layer and the current collector in the secondary battery to be obtained. Further, cycle characteristics can be also improved and the resistance increase after cycles can be suppressed. Moreover, the water resistance of the negative electrode can be improved.

In this specification, the cross-linking agent that satisfies the following condition can be defined as “water-soluble”: when a mixture obtained by adding and stirring 1 mass part of cross-linking agent (in terms of solid content) into 100 mass parts of deionized water is adjusted to satisfy both of the conditions that the temperature is within a range of 20° C. to 70° C. and the pH is within a range of 3 to 12 (for pH adjustment, NaOH solution and/or HCl solution is used) and is filtered through a 250 mesh screen, the mass of the residual solid content left on the screen without passing through the screen does not exceed 50 mass % of the solid content of the cross-linking agent that has been added. Even if the above mixture of the cross-linking agent and water when left still exhibits emulsion state with separated two phases, the cross-linking agent can be identified as water-soluble as long as it satisfies the above definition. To promote good crosslinked structure-forming reaction and improve the adherence strength between the negative-electrode mixed material layer and the current collector as well as cycle characteristics, it is more preferred that the above mixture of the cross-linking agent and water does not separate into two phases (i.e., the mixture being in the form of one-phase water solution); that is, it is more preferred that the cross-linking agent be a one-phase aqueous solution when dissolved in water.

<Particulate Polymer (C)>

The particulate polymer (C) having a functional group reactive with the cross-linking agent (B) and containing an aliphatic conjugated diene monomer unit and an aromatic vinyl monomer unit (hereinafter frequently abbreviated as “particulate polymer (C)”) is a component that can retain the components contained in the electrode member (e.g., electrode active material) from desorbing from the electrode member (e.g., negative electrode) produced with the slurry composition containing the secondary-battery binder composition of the disclosure. If the electrode member is a negative electrode and the negative-electrode mixed material layer is formed with the slurry composition, the particulate polymer in the negative-electrode mixed material layer, when immersed in an electrolysis solution, generally absorbs the electrolysis solution to swell but maintains the granulous shape and binds the negative electrode active materials to prevent the negative electrode active material from coming off the current collector. The particulate polymer even binds the particles other than the negative electrode active material contained in the negative-electrode mixed material layer and serves to maintain the strength of the negative-electrode mixed material layer.

The phrase “containing a monomer unit” as used herein means that “a polymer obtained using the monomer includes a structural unit derived from the monomer”.

The particulate polymer (C) as used herein has a functional group reactive with the functional group of the cross-linking agent (B), such as a carbodiimide group and an oxazoline group, and contains an aliphatic conjugated diene monomer unit and an aromatic vinyl monomer unit. Since the particulate polymer (C) has the functional group reactive with the cross-linking agent (B), the cross-linking in the particulate polymer (C) and between the water-soluble thickener (A) and the particulate polymer (C) can be enabled via the cross-linking agent (B). Further, the particulate polymer (C) is a flexible repeat unit with low rigidity, and is a copolymer having an aliphatic conjugated diene monomer unit capable of increasing binding capacity and an aromatic vinyl monomer unit capable of decreasing the solubility of the polymer to the electrolysis solution to increase the stability of the particulate polymer (C) in the electrolysis solution.

The disclosed secondary-battery binder composition needs to contain the particulate polymer (C) in an amount of 10 mass parts or more, preferably 50 mass parts or more, more preferably 60 mass parts or more, particularly preferably 80 mass parts or more, the most preferably 100 mass parts or more per 100 mass parts of the water-soluble thickener (A). The content of the particulate polymer (C) also needs to be less than 500 mass parts, preferably 300 mass parts or less, more preferably 270 mass parts or less, particularly preferably 250 mass part or less, and the most preferably 150 mass parts or less per 100 mass parts of the water-soluble thickener (A). The secondary-battery binder composition containing 10 mass parts or more of the particulate polymer (C) per 100 mass parts of the water-soluble thickener (A) can form good crosslinked structures and ensure binding capacity. This can accordingly ensure, for example, the strength of the negative-electrode mixed material layer obtained with the binder composition, so that the expansion of the negative electrode can be sufficiently suppressed. Thus, close adherence between the negative-electrode mixed material layer and the current collector can be ensured. On the other hand, the secondary-battery binder composition containing less than 500 mass parts of the particulate polymer (C) per 100 mass parts of the water-soluble thickener (A) can ensure the injectability of the electrolysis solution and the water resistance of the negative electrode. Further, mixing of impurities, such as emulsifier left in the particulate polymer (C), into the electrolysis solution can be suppressed. This consequently prevents degradation of cycle characteristics.

The “particulate polymer” is a polymer dispersible into an aqueous medium such as water, which exists in the aqueous medium in the form of particulates. When dissolving 0.5 g of particulate polymer in 100 g of water at 25° C., in general, 90 mass % or more of the particulate polymer would remain as an insoluble matter.

Examples of the functional group reactive with the cross-linking agent (B) in the particulate polymer (C) includes a carboxyl group, a hydroxy group, a glycidyl ether group, and a thiol group. Of these, considering the cycle characteristics of the secondary battery obtained with the disclosed secondary-battery binder composition, the particulate polymer (C) preferably has one or more of a carboxyl group, a hydroxy group, or a thiol group; and further preferably has at least one of a carboxyl group or a hydroxy group. In addition, it is particularly preferred that the particulate polymer (C) have both of a carboxyl group and a hydroxy group to concurrently achieve cycle characteristics and suppression of expansion of the negative electrode caused by discharge and charge.

[Monomer Used in Preparation of Particulate Polymer (C)]

Examples of the aliphatic conjugated diene monomer that can form the aliphatic conjugated diene monomer unit of the particulate polymer (C) include, without particular limitation, 1,3-butadiene, 2-methyl-1,3-butadiene, 2,3-dimethyl-1,3-butadiene, 2-chloro-1,3-butadiene, substituted linear conjugated pentadienes, and substituted and side-chain conjugated hexadienes. Of these, 1,3-butadiene is preferred. The aliphatic conjugated diene monomer may be used alone or in combination of two or more thereof at any ratio.

The content proportion of the aliphatic conjugated diene monomer unit in the particulate polymer (C) is preferably 20 mass % or more, more preferably 30 mass % or more, but preferably 70 mass % or less, more preferably 60 mass % or less, particularly preferably 55 mass % or less. With the content proportion of the aliphatic conjugated diene monomer unit being 20 mass % or more, the flexibility of the negative electrode can be increased. With the content proportion being 70 mass % or less, the negative-electrode mixed material layer can demonstrate good adherence to the current collector, and the negative electrode obtained with the disclosed secondary-battery binder composition can have improved electrolysis-solution resistance.

Examples of the aromatic vinyl monomer that can form the aromatic vinyl monomer unit of the particulate polymer (C) include, without particular limitation, styrene, α-methylstyrene, vinyltoluene, and divinyl benzene. Of these, styrene is preferred. The aromatic vinyl monomer may be used alone or in combination of two or more thereof at any ratio.

The content proportion of the aromatic vinyl monomer unit in the particulate polymer (C) is preferably 30 mass % or more, more preferably 35 mass % or more, but preferably 79.5 mass % or less, more preferably 69 mass % or less. With the content proportion of the aromatic vinyl monomer unit being 30 mass % or more, the negative electrode obtained with the disclosed secondary-battery binder composition can have improved electrolysis-solution resistance. With the content proportion being 79.5 mass % or less, the negative-electrode mixed material layer can demonstrate good adherence to the current collector.

The particulate polymer (C) preferably contains a 1,3-butadiene unit as the aliphatic conjugated diene monomer unit and a styrene unit as the aromatic vinyl monomer unit; that is, the particulate polymer (C) is preferably a styrene-butadiene copolymer.

In this regard, the particulate polymer (C) needs to have a functional group reactive with the cross-linking agent (B). In other words, the particulate polymer (C) needs to have a monomer unit that contains a functional group reactive with the cross-linking agent (B). Examples of the monomer unit containing the functional group reactive with the cross-linking agent (B) include a monomer unit of ethylenic unsaturated carboxylic acid, an unsaturated monomer unit having a hydroxy group, an unsaturated monomer unit having a glycidyl ether group, and a monomer unit having a thiol group.

Examples of the ethylenic unsaturated carboxylic acid monomer usable in producing the particulate polymer (C) having a carboxylic acid group as the functional group reactive with the cross-linking agent (B) include monocarboxylic acids and dicarboxylic acids, such as acrylic acid, methacrylic acid, crotonic acid, maleic acid, fumaric acid, and itaconic acid; and anhydrides thereof. Of these, considering the stability of the slurry composition containing the disclosed binder composition, preferred examples of the ethylenic unsaturated carboxylic acid monomer are acrylic acid, methacrylic acid, and itaconic acid. These may be used alone or in combination of two or more thereof at any ratio.

Examples of the unsaturated monomer having a hydroxy group usable in producing the particulate polymer (C) having a hydroxy group as the functional group reactive with the cross-linking agent (B) include 2-hydroxyethyl acrylate, 2-hydroxyethyl methacrylate, hydroxypropyl acrylate, hydroxypropyl methacrylate, hydroxybutyl acrylate, hydroxybutyl methacrylate, 3-chloro-2-hydroxypropyl methacrylate, di-(ethylene glycol)maleate, di-(ethylene glycol)itaconate, 2-hydroxyethyl maleate, bis(2-hydroxyethyl)maleate, and 2-hydroxyethyl methyl fumarate. Of these, 2-hydroxyethyl acrylate is preferred. These may be used alone or in combination of two or more thereof at any ratio.

Examples of the unsaturated monomer having a glycidyl ether group usable in producing the particulate polymer (C) having a glycidyl ether group as the functional group reactive with the cross-linking agent (B) include glycidyl acrylate and glycidyl methacrylate. Of these, glycidyl methacrylate is preferred. These may be used alone or in combination of two or more thereof at any ratio.

Examples of the monomer unit having a thiol group usable in producing the particulate polymer (C) having a thiol group as the functional group reactive with the cross-linking agent (B) include pentaerythritol tetrakis (3-mercapto butyrate), trimethylolpropane tris (3-mercapto butyrate), and trimethylolethane tris (3-mercapto butyrate). Of these, pentaerythritol tetrakis (3-mercapto butyrate) is preferred. These may be used alone or in combination of two or more thereof at any ratio.

The functional group reactive with the cross-linking agent (B) in the particulate polymer (C) may be introduced by using the aforementioned monomers containing the functional group reactive with the cross-linking agent (B) for polymerization. However, the functional group reactive with the cross-linking agent (B) may also be introduced for example by polymerizing particulate polymers without any functional group reactive with the cross-linking agent (B) and then substituting the functional group reactive with the cross-linking agent (B) for some or all of the functional groups in the particulate polymer to prepare the particulate polymer (C). In this regard, the repeat unit in the particulate polymer (C) having the “functional group reactive with the cross-linking agent (B)” introduced as such is also included in the “monomer unit containing a functional group reactive with the cross-linking agent (B)”.

The content proportion of the monomer unit containing the functional group reactive with the cross-linking agent (B) in the particulate polymer (C) is not particularly limited; however, the upper limit of thereof is preferably at most 10 mass %, more preferably at most 8 mass %, particularly preferably at most 5 mass %; and the lower limit thereof is preferably not less than 0.5 mass %, more preferably not less than 1.0 mass %, particularly preferably not less than 1.5 mass %. With the content proportion of the above monomers being within the above range, the particulate polymer (C) to be obtained would demonstrate superior mechanical stability and chemical stability.

The particulate polymer (C) may contain any additional repeat unit other than the aforementioned repeat unit, as long as advantageous effects of the disclosed products are not significantly reduced. Examples of the monomer corresponding to the aforementioned additional repeat unit include a vinyl cyanide monomer, an unsaturated carboxylic acid alkyl ester monomer, and an unsaturated carboxylic acid amide monomer. These may be used alone or in combination of two or more thereof at any ratio.

Examples of the vinyl cyanide monomer include acrylonitrile, methacrylonitrile, α-chloracrylonitrile, and α-ethylacrylonitrile. Of these, acrylonitrile and methacrylonitrile are preferred. These may be used alone or in combination of two or more thereof at any ratio.

Examples of the unsaturated carboxylic acid alkyl ester monomer include methyl acrylate, methyl methacrylate, ethyl acrylate, ethyl methacrylate, butyl acrylate, dimethyl fumarate, diethyl fumarate, dimethyl maleate, diethyl maleate, dimethyl itaconate, monomethyl fumarate, monoethyl fumarate, and 2-ethylhexyl acrylate. Of these, methyl methacrylate is preferred. These may be used alone or in combination of two or more thereof at any ratio.

Examples of the unsaturated carboxylic acid amide monomer include acrylamide, methacrylamide, N-methylolacrylamide, N-methylol methacrylamide, and N,N-dimethylacrylamide. Of these, acrylamide and methacrylamide are preferred. These may be used alone or in combination of two or more thereof at any ratio.

Additionally, the particulate polymer (C) may also be produced with monomers used in common emulsion polymerization, such as ethylene, propylene, vinyl acetate, vinyl propionate, vinyl chloride, and vinylidene chloride. These may be used alone or in combination of two or more thereof at any ratio.

The content proportion of the monomer units other than the aliphatic conjugated diene monomer unit, the aromatic vinyl monomer unit, and the monomer unit containing the functional group reactive with the cross-linking agent (B) in the particulate polymer (C) is not particularly limited; however, the upper limit of thereof in total is preferably at most 10 mass %, more preferably at most 8 mass %, particularly preferably at most 5 mass %; and the lower limit thereof in total is preferably not less than 0.5 mass %, more preferably not less than 1.0 mass %, particularly preferably not less than 1.5 mass %.

[Preparation of Particulate Polymer (C)]

The particulate polymer (C) is produced for example by polymerizing a monomer composition containing the aforementioned monomers in an aqueous solvent.

The content proportion of each monomer in the monomer composition is usually the same as the content proportion of the repeat unit in the desired particulate polymer (C).

The aqueous solvent can be selected from any aqueous solution that allows the particulate polymer (C) to be dispersed therein in the form of particulate and, usually, has a boiling point of usually 80° C. or higher, preferably 100° C. or higher, but usually 350° C. or lower, preferably 300° C. or lower, under normal pressure.

Specific examples of the aqueous solvent include water; ketones, such as diacetone alcohol and γ-butyrolactone; alcohols, such as ethyl alcohol, isopropyl alcohol, and normal-propyl alcohol; glycol ethers, such as propylene glycol monomethyl ether, methyl cellosolve, ethyl cellosolve, ethylene glycol tertiary butyl ether, butyl cellosolve, 3-methoxy-3-methyl-1-butanol, ethylene glycol monopropyl ether, diethylene glycol monobutyl ether, triethylene glycol monobutyl ether, and dipropylene glycol monomethyl ether; and ethers, such as 1,3-dioxolane, 1,4-dioxolane, and tetrahydrofuran. Of these, water is particularly preferred since it is not combustible and easily allows dispersion of the particulates of the polymer particulate (C). In some cases, water may be mainly used as the solvent, but any aqueous solvent mentioned above other than water may be mixed to water as long as the dispersing state of the particulate of the particulate polymer (C) can be secured.

Any polymerization method can be used without particular limitation. For example, solution polymerization, suspension polymerization, bulk polymerization, or emulsion polymerization may be used. The polymerization may be ionic polymerization, radical polymerization, or living radical polymerization. Emulsion polymerization is particularly preferred considering the production efficiency. With the emulsion polymerization, high molecular weight product can be easily produced, and the polymerized product can be obtained in the state of being dispersed in water, which eliminates the need to redisperse the product and thus allows the product to be directly used in the production of the disclosed binder composition or the slurry composition. The emulsion polymerization can be performed with the usual manner.

The emulsifier, dispersant, polymerization initiator, polymerization assistant, and the like used in the polymerization may be those commonly used; the used amounts thereof are also the amounts generally used. In the polymerization, seed particles may be used to perform seed polymerization. Also, polymerization conditions may be suitably selected depending on the polymerization method and the kind of polymerization initiator.

The aqueous dispersion of the particulates of the particulate polymer (C) obtained by any of the aforementioned polymerization methods may be adjusted to have a pH range of usually 5 or higher, and usually 10 or lower, preferably 9 or lower using a basic aqueous solution containing for example hydroxides of alkali metals (e.g., Li, Na, K, Rb, and Cs), ammonia, inorganic ammonium compounds (e.g., NH₄Cl), or an organic amine compound (e.g., ethanolamine and diethylamine). The pH adjustment with the use of an alkali metal hydroxide is preferred since it improves the adherence between the current collector and the negative-electrode mixed material layer.

[Properties of Particulate Polymer (C)]

The particulate polymer (C) is usually water-insoluble. Therefore, the particulate polymer (C) usually exists in an aqueous binder composition or in an aqueous slurry composition in the form of particulate. Maintaining the particulate form, the particulate polymer (C) is included for example in a secondary-battery negative electrode.

The number average particle diameter of the particulate polymer (C) in the disclosed binder composition and the slurry composition is preferably 50 nm or greater, more preferably 70 nm or greater, but preferably 500 nm or less, more preferably 400 nm or less. With the number average particle diameter being within the above range, the negative electrode to be obtained can demonstrate good strength and flexibility. The number average particle diameter can be easily measured for example with a transmission electron microscope method, a Coulter Counter, or a laser diffraction scattering method.

The gel content of the particulate polymer (C) is preferably 50 mass % or more, more preferably 80 mass % or more, but preferably 98 mass % or less, more preferably 95 mass % or less. When the gel content of the particulate polymer (C) is less than 50 mass %, the particulate polymer (C) would decrease its cohesive force, possibly causing insufficient adherence to the current collector and the like. On the other hand, when the gel content of the particulate polymer (C) exceeds 98 mass %, the particulate polymer (C) would lose toughness to become brittle, also possibly causing insufficient adherence.

The “gel content” of the particulate polymer (C) herein can be measured with the measuring method described in the example section of the present specification.

The glass-transition temperature (T_{g}) of the particulate polymer (C) is preferably −30° C. or higher, more preferably −20° C. or higher, but preferably 80° C. or lower, more preferably 30° C. or lower. With the glass-transition temperature of the particulate polymer (C) being −30° C. or higher, the ingredients of the slurry composition containing the disclosed secondary-battery binder composition can be prevented from being cohered to sink. This ensures the stability of the slurry composition and can suppress the expansion of the negative electrode suitably. On the other hand, with the glass-transition temperature of the particulate polymer (C) being 80° C. or lower, the disclosed slurry composition containing the secondary-battery binder composition can be applied onto the current collector or the like with good workability.

The “glass-transition temperature” of the particulate polymer (C) herein can be measured with the measuring method described in the example section of the present specification.

The glass-transition temperature and the gel content of the particulate polymer (C) can be appropriately adjusted by varying the preparation conditions (e.g., monomer to be used, polymerization condition, etc.) of the particulate polymer (C).

The glass-transition temperature can be adjusted by varying the kind and the amount of the monomer to be used. For example, the use of the monomer of styrene, acrylonitrile, or the like can raise the glass-transition temperature, and the use of the monomer of butyl acrylate, butadiene, or the like can lower the glass-transition temperature.

The gel content can be adjusted by varying for example the polymerization temperature, the kind of polymerization initiator, the kind and the amount of molecular weight modifier, and conversion ratio at the end of the reaction. For example, if the amount of a chain transfer agent is decreased, the gel content can be increased; and if the amount of the chain transfer agent is increased, the gal content can be decreased.

<Preparation of Binder Composition>

The disclosed binder composition can be prepared by adding the water-soluble thickener (A), the cross-linking agent (B), and optionally other components in a range that does not limit the effects of the disclosed products, to the water dispersion of the particulate polymer (C) obtained by polymerizing the monomer composition.

(Slurry Composition for Secondary-Battery Electrode)

The slurry composition for secondary-battery electrode of the disclosure contains the water-soluble thickener (A) having a hydroxy group or a carboxyl group, the cross-linking agent (B) having a carbodiimide group or an oxazoline group, the particulate polymer (C), an electrode active material, and water. The particulate polymer (C) has a functional group reactive with the cross-linking agent (B), and contains an aliphatic conjugated diene monomer unit and an aromatic vinyl monomer unit. The disclosed slurry composition for the secondary-battery electrode contains 0.001 mass parts or more but less than 100 mass parts of the cross-linking agent (B) and 10 mass parts or more but less than 500 mass parts of the particulate polymer (C) per 100 mass parts of the water-soluble thickener (A). The disclosed slurry composition for secondary battery electrode allows formation of an electrode mixed material layer that demonstrates superior adherence to the current collector and can improve the electrical characteristics of the secondary battery.

The water-soluble thickener (A), the cross-linking agent (B), and the particulate polymer (C) contained in the disclosed slurry composition for secondary-battery electrode are the same as those described for the secondary-battery binder composition of the disclosure in the above. The blending proportion thereof is also the same as those of the disclosed binder composition.

<Electrode Active Material>

The electrode active material is a material that gives and receives electrons in the electrodes (positive electrode and negative electrode) of the secondary battery. In the following, the electrode active material used in the negative electrode of a lithium ion secondary battery (negative electrode active material) will be described as an example.

As the negative electrode active material of the lithium ion secondary battery, a material that can occlude and release lithium is usually used. Examples of the material that can occlude and release lithium include a carbon-based negative electrode active material, metal-based negative electrode active material, and a negative electrode active material formed by combining these two.

The carbon-based negative electrode active material can be defined as an active material that contains carbon as its main backbone, to which lithium can be inserted (or can be doped). Examples of the carbon-based negative electrode active material include carbonaceous materials and graphite materials.

The carbonaceous material is a material with low degree of graphitization (i.e., with low crystallinity), which can be obtained by heat-treating a carbon precursor at 2000° C. or lower to carbonate it. The lower limit of the heat treatment temperature in the carbonation is not particularly limited, but is for example 500° C. or higher.

Examples of the carbonaceous material include graphitizing carbon that easily changes its carbon structure depending on the heat treatment temperature and non-graphitizing carbon having a structure close to the amorphous structure typified by glassy carbon.

Examples of the graphitizing carbon include carbon materials made of tar pitch obtained from petroleum or coal. Specific examples include coke, meso-carbon microbeads (MCMB), mesophase pitch-based carbon fiber, and pyrolytic vapor-grown carbon fiber.

Examples of the non-graphitizing carbon include a phenol resin fired body, polyacrylonitrile-based carbon fiber, pseudo-isotropic carbon, a furfuryl alcohol resin fired body (PFA), and hard carbon.

The graphite material is a material having a high crystallinity close to graphite, which is obtained by heat-treating graphitizing carbon at 2000° C. or higher. The upper limit of the heat treatment temperature is not particularly limited, but is for example 5000° C. or lower.

Examples of the graphitizing material include natural graphite and artificial graphite.

Examples of the artificial graphite include an artificial graphite obtained by heat-treating a carbon containing graphitizing carbon mostly at 2800° C. or higher, graphitized MCMB obtained by heat-treating MCMB at 2000° C. or higher, and graphitized mesophase pitch-based carbon fiber obtained by heat-treating mesophase pitch-based carbon fiber at 2000° C. or higher.

In the disclosed products, natural graphite whose surface is at least partially coated with amorphous carbon (amorphous-coated natural graphite) is preferably used as the carbon-based negative electrode active material. With the use of amorphous-coated natural graphite, the density of the negative-electrode mixed material layer to be obtained can be improved, so that close adherence between the current collector and the negative-electrode mixed material layer as well as the cycle characteristics of the secondary battery can be ensured.

Alternatively, a mixture of the amorphous-coated natural graphite and artificial graphite may be used as the negative electrode active material. In this regard, while artificial graphite is bulkier than the amorphous-coated natural graphite, the particles of thereof can be readily crushed. Thus, when an electrode is pressed, the particles tend to be oriented. Accordingly, such oriented particles align on the electrode surface, possibly preventing the entry of the electrolysis solution. Considering this, when the mixture of the amorphous-coated natural graphite and artificial graphite is used as the negative electrode active material, the proportion of the blending amount of the amorphous-coated natural graphite in the total blending amount of the amorphous-coated natural graphite and artificial graphite is preferably 30 mass % or more, more preferably 60 mass % or more, and particularly preferably 80 mass % or more.

The amorphous-coated natural graphite can be produced with any method known in the art. In one example, the amorphous-coated natural graphite can be produced for example by covering the surface of natural graphite with a pitch made of petroleum residues, and heating the pitch-coated natural graphite at about 1000° C.

The metal-based negative electrode active material is an active material containing metal, the structure of which usually contains an element to which lithium can be inserted. When lithium is inserted, the metal-based negative electrode active material exhibits a theoretical electric capacitance of 500 mAh/g or higher per unit mass. Examples of the metal-based active material include a lithium metal; a simple substance of metal that can form a lithium alloy (e.g., Ag, Al, Ba, Bi, Cu, Ga, Ge, In, Ni, P, Pb, Sb, Si, Sn, Sr, Zn, and Ti); alloys of the simple substance of metal; and oxides, sulfides, nitrides, silicides, carbides, and phosphides of the lithium metal, the simple substance of metal, and the alloys of the simple substance of metal.

Of the metal-based negative electrode active materials, an active material containing silicon (silicon-based negative electrode active material) is preferred. With the use of the silicon-based negative electrode active material, the capacity of the lithium ion secondary battery can be increased.

Examples of the silicon-based negative electrode active material include silicon (Si), a silicon-containing alloy, SiO, SiOₓ, a mixture of Si-containing material and carbon material, and a composite material of conductive carbon and a Si-containing material obtained by coating or combining a Si-containing material with conductive carbon.

The silicon-containing alloy may be for example an alloy that contains silicon, aluminum, iron, and rare-earth elements such as tin and yttrium. Such an alloy can be prepared for example by a melt spinning method. Examples of such an alloy include those described in JP2013-65569A.

SiO is a compound that contains Si and at least one of SiO or SiO₂, where x is usually 0.01 or greater but less than 2. SiO can be formed for example by utilizing the disproportionation reaction of silicon monoxide (SiO). Specifically, SiO can be prepared by heat-treating SiO optionally in the presence of a polymer such as polyvinyl alcohol, and producing silicon and silicon dioxide. The heat-treatment can be performed, after pulverizing and mixing SiO optionally with the polymer, at a temperature of 900° C. or higher, preferably 1000° C. or higher, in the atmosphere containing an organic gas and/or vapor.

The mixture of Si-containing material and carbon material may be obtained by pulverizing and mixing the Si-containing material, such as silicon and SiOₓ, with a carbon material, such as a carbonaceous material and graphite material, optionally in the presence of a polymer such as polyvinyl alcohol. As the carbonaceous material and the graphite material, any material usable as the carbon-based negative electrode active material can be used.

The composite material of Si-containing material and conductive carbon may be for example a compound obtained by heat-treating a pulverized mixture of SiO, a polymer such as polyvinyl alcohol, and optionally a carbon material, in the atmosphere containing for example an organic gas and/or vapor. Alternatively, the composite material of Si-containing material and conductive carbon may be obtained for example by coating the surface using a chemical vapor deposition method that uses an organic gas or the like, or by making the SiO particles and graphite or artificial graphite into composite particles (or by granulating the SiO particles and graphite or artificial graphite) by a mechanochemical method, which methods are publicly known in the art.

In this regard, if the carbon-based negative electrode active material or the metal-based negative electrode active material is used as the negative electrode active material, such a negative electrode active material would expand and contract in accordance with discharge and charge. For this, if such a negative electrode active material is used, the negative electrode usually expands gradually in accordance with the repeated expansion and contraction of the negative electrode active material. This may change the shape of the secondary battery to lower the electrical characteristics such as cycle characteristics. However, the negative electrode formed with the disclosed binder composition, which has crosslinked structures formed by the aforementioned water-soluble thickener (A), the cross-linking agent (B), and the particulate polymer (C), would be suppressed from expanding, which is caused due to the expansion and contraction of the negative electrode active material. This would improve the cycle characteristics.

In this regard, the use of the aforementioned silicon-based negative electrode active material may increase the capacity of the lithium ion secondary battery; however, in general, silicon-based negative electrode active materials substantially expand and contract (for example about five-fold) in accordance with discharge and charge. Accordingly, to sufficiently suppress the expansion of the negative electrode while increasing the capacity of the lithium ion secondary battery, it is preferred that a mixture of the carbon-based negative electrode active material and the silicon-based negative electrode active material be used as the negative electrode active material.

In using the mixture of the carbon-based negative electrode active material and the silicon-based negative electrode active material as the negative electrode active material, to sufficiently suppress the expansion of the negative electrode while sufficiently increasing the capacity of the lithium ion secondary battery, the carbon-based negative electrode active material is preferably artificial graphite, and the silicon-based negative electrode active material is preferably one or more materials selected from the group consisting of Si, a silicon-containing alloy, SiOₓ, a mixture of Si-containing material and carbon material, and a composite material of Si-containing material and conductive carbon. More preferably, the silicon-based negative electrode active material is at least one of silicon-containing alloy or the composite material of Si-containing material and conductive carbon, and particularly preferably at least one of the silicon-containing alloy or a composite material in which SiOₓ is dispersed in the matrix of conductive carbon (Si—SiOₓ—C composite). While these negative electrode active materials may occlude and release relatively large amounts of lithium, their volume changes are relatively small even after they occlude and release lithium. Accordingly, the use of these negative electrode active materials can suppress a volume increase of the negative electrode active material during charging/discharging while sufficiently increasing the capacity of the lithium ion secondary battery including the negative electrode for lithium ion secondary battery formed with the slurry composition. If the silicon-containing alloy is used, initial coulombic efficiency and cycle characteristics can be also improved while the capacity of the lithium ion secondary battery is sufficiently increased.

When the mixture of the carbon-based negative electrode active material and the silicon-based negative electrode active material is used as the negative electrode active material, to sufficiently suppress the expansion of the negative electrode while sufficiently increasing the capacity of the lithium ion secondary battery, the negative electrode active material preferably contains the silicon-based negative electrode active material in an amount of more than 0 mass parts but 100 mass parts or less, more preferably 10 mass parts or more but 70 mass parts or less, and particularly preferably 30 mass parts or more but 50 mass parts or less per 100 mass parts of the carbon-based negative electrode active material. With the negative electrode active material containing the silicon-based negative electrode active material (i.e., the negative electrode active material containing more than 0 mass parts of the silicon-based negative electrode active material per 100 mass parts of the carbon-based negative electrode active material), the capacity of the lithium ion secondary battery can be sufficiently increased. Further, by setting the amount of the silicon-based negative electrode active material to 100 mass parts or less per 100 mass parts of the carbon-based negative electrode active material, the expansion of the negative electrode can be sufficiently suppressed.

The particle diameter and specific surface area of the negative electrode active material may be, but not particularly limited to, the same particle diameter and specific surface area as the negative electrode active material conventionally used.

The disclosed slurry composition for secondary-battery electrode preferably contains 5000 mass parts or more, more preferably 8000 mass parts or more, but preferably 15000 mass parts or less, more preferably 12000 mass parts or less of the negative electrode active material per 100 mass parts of the water-soluble thickener (A).

With the slurry composition for secondary-battery electrode that preferably contains 5000 mass parts or more of the negative electrode active material per 100 mass parts of the water-soluble thickener (A), the electron giving/receiving in the secondary-battery negative electrode obtained with the slurry composition is sufficiently ensured, so that good function of the secondary battery is ensured. With the slurry composition that contains 15000 mass parts or less of the negative electrode active material per 100 mass parts of the water-soluble thickener, the expansion of the negative electrode is suppressed, and the workability upon applying the slurry composition onto the current collector can be ensured.

<Other Components>

The disclosed slurry composition for secondary-battery electrode may further contain other components, such as a conductive material, a reinforcing material, a leveling agent, and an electrolysis solution additive, other than the aforementioned components. The other components may be any publicly known materials that do not affect the battery reaction. For example, those described in WO2012/115096A may be used. These components may be used alone or in combination of two or more thereof at any ratio. The disclosed secondary-battery binder composition may instead contain the other components.

<Preparation of Slurry Composition>

The disclosed slurry composition for secondary-battery electrode may be prepared by optionally premixing part of the aforementioned components, and then dispersing them into an aqueous medium as a dispersion medium; or may be prepared by preparing the disclosed binder composition containing the water-soluble thickener (A), the cross-linking agent (B), and the particulate polymer (C), and then dispersing the binder composition and the electrode active material into an aqueous medium as a dispersion medium. Considering the dispersibility of each component in the slurry composition, it is preferred that the slurry composition containing the water-soluble thickener (A), the cross-linking agent (B), and the particulate polymer (C) (i.e., containing the disclosed binder composition) be prepared by dispersing each component into an aqueous medium as a dispersion medium. Specifically, it is preferred that the slurry composition be prepared by mixing the aforementioned components with the aqueous medium by using a mixer, such as a ball mill, a sand mill, a bead mill, a pigment disperser, a grinding machine, an ultrasonic disperser, a homogenizer, a planetary mixer, and a FILMIX.

Typically, the aqueous medium used is water; however, an aqueous solution of appropriate compound or a mixed solution of a small amount of organic medium and water may also be used. The solid content concentration of the slurry composition may be for example 30 mass % or more but 90 mass % or less, more preferably 40 mass % or more but 80 mass % or less, with which the components can be uniformly dispersed. Further, the mixing of the above components with the aqueous medium can be performed for 10 minutes or more but a few hours or less at a temperature ranging from room temperature to 80° C.

(Secondary-Battery Negative Electrode)

The secondary-battery negative electrode of the disclosure can be produced with the disclosed slurry composition for secondary-battery electrode.

The disclosed secondary-battery negative electrode includes a current collector and a negative-electrode mixed material layer formed on the current collector. The negative-electrode mixed material layer is obtained from the disclosed slurry composition for secondary-battery electrode whose electrode active material is a negative electrode active material. The disclosed secondary-battery negative electrode can exhibit improved adherence between the current collector and the negative-electrode mixed material layer and improve the electrical characteristics of the secondary battery.

The disclosed secondary-battery negative electrode is produced, for example, through a step of applying the aforementioned slurry composition for secondary-battery electrode onto the current collector (applying step), a step of drying the slurry composition for secondary-battery electrode applied onto the current collector to form a negative-electrode mixed material layer on the current collector (drying step), and optionally a step of further heating the negative-electrode mixed material layer (heating step). When this producing method is used, the heat applied in the drying step or the heat applied in the heating step will progress the cross-linking reaction via the cross-linking agent (B). In other words, crosslinked structures in the water-soluble thickener (A), between the water-soluble thickener (A) and the particulate polymer (C), and in the particulate polymer (C) via the cross-linking agent (B) are formed in the negative-electrode mixed material layer. The crosslinked structures allow suppression of the expansion possibly caused due to discharge and charge, and improve adherence between the current collector and the negative-electrode mixed material layer. Further, the crosslinked structures improve electrical characteristics of the secondary battery by, for example, improving the cycle characteristics and also suppressing the resistance increase after cycles.

Moreover, the formation of crosslinked structures makes the water-soluble thickener (A), the cross-linking agent (B), and the particulate polymer (C) incorporated in the crosslinked structures less soluble and less dispersible into water, which improves the water resistance of the negative electrode. Conventionally, in forming a porous membrane on a polar plate having an electrode mixed material layer obtained from an aqueous slurry composition for the purpose of for example improving strength and heat resistance, the use of an aqueous slurry composition for porous membrane may cause elution of a water-soluble component, such as a water-soluble thickener contained in the electrode mixed material layer, into the slurry composition for porous membrane applied onto the electrode mixed material layer. This often results in a problem of impaired battery characteristics. However, the secondary-battery negative electrode formed from the disclosed slurry composition, which has improved water resistance as mentioned above, can sufficiently ensure the battery characteristics even if a porous membrane made of an aqueous porous membrane slurry composition is formed on the negative-electrode mixed material layer. Furthermore, the formation of the crosslinked structures loosens the tangled molecular chains in the water-soluble thickener (A) to improve the wettability to the electrolysis solution, thus improving the injectability of the electrolysis solution in producing the secondary battery.

[Applying Step]

The aforementioned slurry composition for secondary-battery electrode can be applied onto the current collector by any method publicly known. Specifically, the slurry composition may be applied for example by doctor blading, dip coating, reverse roll coating, direct roll coating, gravure coating, extrusion coating, or brush coating. The slurry composition may be applied onto one side or both sides of the current collector. The thickness of the slurry coating applied onto the current collector before drying may be appropriately determined in accordance with the thickness of the negative-electrode mixed material layer to be obtained after drying.

The current collector to be coated with the slurry composition is made of a material having electrical conductivity and electrochemical durability. Specifically, the current collector may be made for example of iron, copper, aluminum, nickel, stainless steel, titan, tantalum, gold, or platinum. Of these, copper foil is particularly preferred as the current collector used for a negative electrode. The aforementioned materials may be used alone or in combination of two or more thereof at any ratio.

[Drying Step]

The slurry composition applied onto the current collector may be dried by any method publicly known, for example, drying by warm, hot, or low-humidity air; drying in a vacuum; or drying by irradiation of infrared light or electron beams. By drying the slurry composition on the current collector as above, a negative-electrode mixed material layer is formed on the current collector, and a secondary-battery negative electrode including the current collector and the negative-electrode mixed material layer can be obtained. In drying the slurry composition, the heat applied progresses the cross-linking reaction via the cross-linking agent (B).

After the drying step, the negative-electrode mixed material layer may be subjected to a pressing treatment, such as mold pressing or roll pressing. The pressing treatment can improve the adherence between the negative-electrode mixed material layer and the current collector.

Further, it is preferred that, after forming the negative-electrode mixed material layer, heating step be performed to progress the cross-linking reaction to obtain even more sufficient crosslinked structures. The heating step is performed preferably for about 1 hour or more but 20 hours or less at 80° C. or higher but 160° C. or lower.

(Secondary Battery)

The secondary battery of the disclosure includes a positive electrode, a negative electrode, an electrolysis solution, and a separator, in which the negative electrode is the secondary-battery negative electrode disclosed herein. The disclosed secondary battery, which employs the disclosed secondary-battery negative electrode, can demonstrate improved electrical characteristics, and also ensures the close adherence between the negative-electrode mixed material layer and the current collector. The disclosed secondary battery can find application suitably in, for example, cell-phones such as smartphones, tablets, personal computers, electric vehicles, and stationary-type emergency storage batteries.

<Positive Electrode>

The positive electrode used in the secondary battery may be, when the secondary battery is a lithium ion secondary battery, a known positive electrode used as the positive electrode for the lithium ion secondary battery. Specifically, the positive electrode used may be for example a positive electrode obtained by forming a positive-electrode mixed material layer on the current collector.

The current collector may be made of a metal material such as aluminum. The positive-electrode mixed material layer may be a layer containing a known positive electrode active material, a conductive material, and a binder, wherein the binder may be the secondary-battery binder composition disclosed herein.

<Electrolysis Solution>

The electrolysis solution used may be obtained by dissolving an electrolyte in a solvent.

The solvent used here may be an organic solvent that can dissolve an electrolyte. Specifically, the solvent may be an alkyl carbonate solvent, such as ethylene carbonate, propylene carbonate, and γ-butyrolactone, to which a viscosity modification solvent, such as 2,5-dimethyl tetrahydrofuran, tetrahydrofuran, diethyl carbonate, ethylmethyl carbonate, dimethyl carbonate, methyl acetate, dimethoxyethane, dioxolane, methyl propionate, or methyl formate, is added.

The electrolyte used may be a lithium salt. Examples of the lithium salt include those described in JP2012-204303A. Of the lithium salts, LiPF₆, LiClO₄, and CF₃SO₃Li are preferred as electrolytes because they readily dissolve in organic solvents and demonstrate a high degree of dissociation.

The electrolysis solution may be a gel electrolyte that contains a polymer and the above electrolysis solution, and further may be an intrinsic polymer electrolysis.

<Separator>

Examples of the separator used include those described in JP2012-204303A. Of these, a fine porous membrane made of polyolefinic resin (polyethylene, polypropylene, polybutene, and polyvinyl chloride) is preferred, because such a membrane can reduce the total thickness of the separator, increasing the ratio of the electrode active material in the secondary battery to increase the capacity per volume. The separator may include a porous membrane obtained by binding non-conductive particles with the disclosed secondary-battery binder composition.

<Method of Producing Secondary Battery>

The disclosed secondary battery may be produced, for example, by laminating a positive electrode and a negative electrode with a separator arranged therebetween, rolling or folding the resulting laminate as necessary in accordance with the battery shape, placing it in a battery container, injecting an electrolysis solution into the battery container, and sealing the container. To prevent pressure increase inside the lithium ion secondary battery and occurrence of overcharge/overdischarge and the like, the lithium ion secondary battery may include an overcurrent preventing device such as a fuse and a PTC device, expanded metal, and a lead plate, as necessary. The secondary battery may take any shape such as a coin, a button, a sheet, a cylinder, a square, or a plane.

### EXAMPLES

Hereinafter, the disclosed products will be described with reference to examples; however, the disclosure is not limited to those examples. In the following, “%” and “parts” used in expressing amounts are by mass, unless otherwise specified.

In the examples and comparative examples, the glass-transition temperature and gel content of the particulate polymer (C); the tensile breaking strength, the wettability to electrolysis solution, and the water resistance of the binder film; the cycle characteristics and the suppression of resistance increase after cycles of the secondary battery; the injectability of electrolysis solution; the adherence between the negative-electrode mixed material layer and the current collector; and the water resistance of the negative electrode were each rated using the methods described below.

<Glass-Transition Temperature of Particulate Polymer (C)>

A water dispersion containing the particulate polymer (C) was dried for 3 days in an environment of a humidity of 50% and temperatures of 23° C. or higher but 25° C. or lower, to obtain a film having a thickness of 1±0.3 mm. This film was dried for 1 hour in a hot air oven at 120° C. Using the film dried as a sample, the glass-transition temperature (° C.) was measured using DSC6220SII (Differential Scanning Calorimeter, manufactured by NanoTechnology Inc.) under the conditions of a measurement temperature of −100° C. or higher but 180° C. or lower and a temperature rise rate of 5° C./min in accordance with JIS K 7121.

### <Gel Content of Particulate Polymer (C)>

A water dispersion containing the particulate polymer (C) was dried in an environment of a humidity of 50% and temperatures of 23° C. or higher but 25° C. or lower, to obtain a film having a thickness of 3±0.3 mm. The film was cut into 1 mm square pieces, and each of the pieces having a mass of about 1 g was precisely weighed.

The mass of a film piece obtained by the cut is denoted as “w0”. The film piece was immersed in 10 g of tetrahydrofuran (THF) for 24 hours in an environment of temperatures of 25° C.±1° C. After that, the film piece was taken out of THF and vacuum-dried for 3 hours at 105° C., to measure an insoluble mass “w1”.

The gel content (mass %) was then calculated in accordance with the following expression:

Gel content(mass %)=(w1/w0)×100

### <Tensile Breaking Strength of Binder Film>

A secondary-battery binder composition was prepared and dried for 3 days in an environment of a humidity of 50% and temperatures of 23° C. or higher but 25° C. or lower, and then was further dried for 1 hour in a hot air oven at 120° C., to obtain a binder film having a thickness of 0.5±0.02 mm.

Using the binder film obtained, a tensile test was conducted at a pulling rate of 50 mm/min in an environment of temperatures of 25±1° C. and dew points of −60±5° C. in accordance with JIS K 6251, to calculate the tensile breaking strength of the binder film. Greater tensile breaking strength values indicate higher resistance to pulling and better mechanical characteristics.

A: the tensile breaking strength is 50 MPa or greater.

B: the tensile breaking strength is 45 MPa or greater but less than 50 MPa.

C: the tensile breaking strength is 40 MPa or greater but less than 45 MPa.

D: the tensile breaking strength is less than 40 MPa.

### <Wettability of Binder Film to Electrolysis Solution>

A secondary-battery binder composition was prepared and was applied to an electrolytic copper foil (NC-WS (registered trademark) manufactured by FURUKAWA ELECTRIC CO., LTD) using a table coater, and was dried with a hot air drier for 20 minutes at 50° C. and then 20 minutes at 120° C., to obtain a binder film having a thickness of 5±2 μm.

For the binder film, using propylene carbonate (reagent manufactured by Kishida Chemical Co., Ltd.) as a solvent used for the electrolysis solution, a contact angle was measured by a half angle method (θ/2 method) using a goniometer (manufactured by Kyowa Interface Science Co., LTD.). The wettability to the electrolysis solution was evaluated with the criteria below. The contact angle exhibits S-type characteristics, and thus smaller values indicate better wettability to an electrolysis solution.

A: the contact angle is less than 35°.

B: the contact angle is less than 45° but 35° or greater.

C: the contact angle is less than 55° but 45° or greater.

D: the contact angle is 55° or greater.

### <Water Resistance of Binder Film>

A secondary-battery binder composition was prepared and was dried for 3 days in an environment of a humidity of 50% and temperatures of 23° C. or higher but 25° C. or lower, and then was further dried for 1 hour in a hot air oven at 120° C., to obtain a binder film having a thickness of 0.5±0.02 mm.

The binder film obtained was cut into 0.5 mm square pieces, and each of the pieces having a mass of about 1 g was precisely weighed. The mass of the film piece obtained by the cut is denoted as “w_{f}0”. The film piece was immersed in 100 g of deionized water (25±1° C.) overnight, and then irradiated with ultrasonic waves for 10 minutes by a ultrasonic cleaner. After that, filtering through a 100 mesh was conducted, and the residue was washed by deionized water and acetone, to obtain a solid content. The solid content obtained was dried for 5 hours in a hot air over at 120° C. to measure a mass “w_{f}1”, and an undissolved amount (in mass %) was calculated in accordance with the expression below:

Undissolved amount(mass %)=(w_{f}1/w_{f}0)×100

The undissolved amount obtained was rated based on the following criteria. Greater undissolved amount values indicate better water resistance.

A: the undissolved amount is 95% or more.

B: the undissolved amount is 85% or more but less than 95%.

C: the undissolved amount is 70% or more but less than 85%.

D: the undissolved amount is less than 70%.

### <Cycle Characteristics of Secondary Battery>

A lithium ion secondary battery of laminated cell was prepared and filled with an electrolysis solution and was left still for 5 hours. The lithium ion secondary battery was charged until the cell voltage reaches 3.65 V using a constant-current method at 0.2 C, then subjected to an aging treatment for 12 hours at 60° C., and discharged until the cell voltage falls down to 3.00 V using a constant-current method at 0.2 C. The lithium ion secondary battery was then charged until the cell voltage reaches 3.82 V using a constant-current method at 0.1 C at 25° C. and was left for 5 hours in that state, and then the voltage of the secondary battery “V₀” was measured. Subsequently, discharging operation at 0.5 C was conducted in an environment of −10° C., and a voltage “V₂₀”, which is a voltage 20 seconds after the discharge initiation, was measured. Then, an initial resistance defined by the voltage change represented by ΔVᵢₙᵢ=V₀−V₂₀ was calculated. This initial resistance will be used in evaluating the suppression of resistance increase after cycles, which will be described later.

The lithium ion secondary battery for which the above initial resistance has been measured was charged until the cell voltage reaches 3.65 V using a constant-current method at 0.2 C in an atmosphere of 25° C. The temperature was then raised to 60° C. to conduct an aging treatment for 12 hours, and the lithium ion secondary battery was discharged until the cell voltage falls down to 3.00 V using a constant-current method at 0.2 C in an atmosphere of 25° C.

Further, a 100-cycle charge/discharge operation was conducted at a charge/discharge rate of 1.0 C at 4.2 V in an environment of 45° C. In this operation, the capacity of the first cycle, or specifically an initial discharge capacity “X1”, and the discharge capacity of the 100th cycle “X2” were measured, and the capacity change rate represented by ΔC=(X2/X1)×100(%) was obtained and rated based on the criteria below. Greater capacity change rate values ΔC indicate better cycle characteristics.

A: ΔC is 85% or higher.

B: ΔC is 83% or higher but less than 85%.

C: ΔC is 80% or higher but less than 83%.

D: ΔC is less than 80%.

<Suppression of Resistance Increase after Cycles>

The lithium ion secondary battery for which the above cycle characteristics have been measured was discharged until the cell voltage falls down to 3.00 V using a constant-current method at 0.05 C at 25° C. After that, the lithium ion secondary battery was charged until the cell voltage reaches 3.82 V using a constant-current method at 0.1 C at 25° C. and was left for 5 hours in that state, and then the voltage of the secondary battery “V₀′” was measured. Subsequently, discharging operation at 0.5 C was conducted in an environment of −10° C., and then a voltage “V₂₀′”, which is a voltage 20 seconds after the discharge initiation, was measured. Then, the resistance after cycles defined by the voltage change represented by ΔV_{fin}=V₀′−V₂₀′ was calculated.

The resistance increase rate was defined by ΔV_{fin}/ΔVᵢₙᵢ and rated based on the criteria below. Smaller resistance increase rate values ΔV_{fin}/ΔVᵢₙᵢ indicate better suppression of resistance increase caused by cycles.

A: ΔV_{fin}/ΔVᵢₙᵢ is 110% or less.

B: ΔV_{fin}/ΔVᵢₙᵢ is higher than 110% but 120% or less.

C: ΔV_{fin}/ΔVᵢₙᵢ is higher than 120% but 130% or less.

D: ΔV_{fin}/ΔVᵢₙᵢ is higher than 130%.

### <Injectability of Electrolysis Solution>

A secondary-battery negative electrode was prepared and was cut into 16 mm-diameter circles, and 1 μL of propylene carbonate (manufactured by Kishida Chemical Co., Ltd., reagent) was dropped onto the surface having a negative-electrode mixed material layer. The time required for the droplet of propylene carbonate on the negative electrode to penetrate into the negative-electrode mixed material layer after the dropping (i.e., penetration time) was visually observed and rated based on the criteria below. Shorter penetration times indicate a better affinity between the negative electrode and the propylene carbonate contained in common electrolysis solutions, which consequently means better injectability of the electrolysis solution during the production of secondary batteries.

A: the penetration time is shorter than 80 seconds.

B: the penetration time is 80 seconds or longer but shorter than 100 seconds.

C: the penetration time is 100 seconds or longer but shorter than 150 seconds.

D: the penetration time is 150 seconds or longer.

### <Adherence Between Negative-Electrode Mixed Material Layer and Current Collector>

A secondary-battery negative electrode was prepared and cut into test pieces of a rectangular shape having a length of 100 mm and a width of 10 mm. With the surface of the test piece on which the negative-electrode mixed material layer is formed facing down, cellophane tape (defined in accordance with JIS Z1522) was attached onto the surface of the negative-electrode mixed material layer. Then, one end of the current collector was vertically pulled at a pulling rate of 50 mm/min to peel off the current corrector. The stress caused by the pulling and peeling was measured (the cellophane tape was secured to the test bench). The measurement was conducted 3 times to calculate the average thereof. The average, determined as the peel strength, was rated based on the criteria below. Greater peel strength values indicate better adherence between the negative-electrode mixed material layer and the current collector.

A: the peel strength is 20 N/m or greater.

B: the peel strength is 15 N/m or greater but less than 20 N/m.

C: the peel strength is 10 N/m or greater but less than 15 N/m.

D: the peel strength is less than 10 N/m.

### <Water Resistance of Negative Electrode>

A secondary-battery negative electrode was prepared and cut into 16 mm-diameter circles. The mass of each circle was measured, and the mass of the current collector was subtracted from the mass of the circle to calculate the mass of the negative-electrode mixed material layer (wₐ1). The circular negative electrode was placed into a sample bottle, and 50 mL of deionized water was poured into the sample bottle, which was then heat-treated for 72 hours at 60° C. Subsequently, the circular negative electrode was taken out and washed with deionized water. After that, the negative electrode was dried for 1 hour at 120° C., and the mass thereof was measured. The mass of the current collector was then subtracted from the mass of the negative electrode to calculate the mass of the negative-electrode mixed material layer (wₐ2). The mass change rate (mass %) caused through the immersion in deionized water and heat treatment was defined by [(wₐ1−wₐ2)/wₐ1]×100, and was rated based on the criteria below. Smaller mass change rate values indicate higher water resistance of the negative electrode.

A: the mass change rate is less than 5%.

B: the mass change rate is 5% or higher but lower than 10%.

C: the mass change rate is 10% or higher but lower than 20%.

D: the mass change rate is 20% or higher.

In the following, products produced by using an oxazoline compound as the cross-linking agent (B) and the products produced by using a carbodiimide compound as the cross-linking agent (B) were each evaluated.

In Examples 1-21 and Comparative Examples 1-6, an oxazoline compound was used as the cross-linking agent (B) to make secondary-battery binder compositions, slurry compositions for secondary-battery negative electrode, secondary-battery negative electrodes, and secondary batteries; and the products were evaluated.

(Materials Used)

The following water-soluble thickener (A), the cross-linking agent (B), and the particulate polymer (C) were used.

### [Water-Soluble Thickener (A)]

CMC1: sodium salt of carboxymethyl cellulose (manufacturer: NIPPON PAPER Chemicals CO., LTD., product name: MAC350HC, degree of etherification: 0.8, viscosity of 1% aqueous solution: 3500 mPa·s)

PAA1: polyacrylic acid (manufacturer: Aldrich, weight-average molecular weight: 450 thousand)

### [Cross-Linking Agent (B)]

Cross-linking agent B1: 2,2′-bis(2-oxazoline) (manufacturer: Tokyo Chemical Industry Co., Ltd., oxazoline equivalent: 70, one-phase water-solution)

Cross-linking agent B2: oxazoline group-containing polymer (manufacturer: NIPPON SHOKUBAI CO., LTD., product name: Epocros (registered trademark) WS-700, oxazoline equivalent: 220, one-phase aqueous solution)

Cross-linking agent B3: oxazoline group-containing polymer (manufacturer: NIPPON SHOKUBAI CO., LTD., product name: Epocros (registered trademark) K-2020E, oxazoline equivalent: 550, emulsion)

### [Particulate Polymer (C)]

Particulate polymer C1 (a polymer having a carboxyl group and a hydroxy group) was prepared as follows:

A 5-MPa pressure vessel equipped with a stirrer was charged with 65 parts of styrene as an aromatic vinyl monomer, 35 parts of 1,3-butadiene as an aliphatic conjugated diene monomer, 4 parts of itaconic acid as an ethylenic unsaturated carboxylic acid monomer, 1 part of 2-hydroxyethyl acrylate as a hydroxy group-containing monomer, 0.3 parts of t-dodecyl mercaptan as a molecular weight modifier, 5 parts of sodium dodecylbenzenesulfonate as an emulsifier, 150 parts of deionized water as a solvent, and 1 part of potassium persulfate as a polymerization initiator. The charge materials were sufficiently stirred and warmed to 55° C. to initiate polymerization.

When the monomer consumption reached 95.0%, the vessel was cooled to terminate the reaction. To the water dispersion containing the polymer thus obtained, 5% sodium hydroxide aqueous solution was added, and the water dispersion was adjusted to pH 8. Then, unreacted monomers were removed by distillation with heat under reduced pressure. Thereafter, the water dispersion was cooled to 30° C. or lower to obtain a water dispersion of particulate polymer C1. Using the water dispersion of particulate polymer C1 obtained, the gel content and the glass-transition temperature of particulate polymer C1 was measured by the aforementioned methods. The measured results demonstrated that the gel content was 92% and the glass-transition temperature (Tg) was 10° C.

### Example 1

### Preparation of Secondary-Battery Binder Composition

In an environment of 25° C., 2 parts of cross-linking agent B1, in terms of solid content, as the cross-linking agent (B), and 150 parts of particulate polymer C1, in terms of solid content, as the particulate polymer (C) were mixed. The mixture was then added to 100 mass parts (in terms of solid content) of the water-soluble thickener (A), which consists of 98 mass parts of CMC1 in terms of solid content and 2 mass parts of PAA1 also in terms of solid content. The secondary-battery binder composition of Examples 1 was thus prepared. Using the secondary-battery binder composition as prepared, a binder film was made by the aforementioned method. The binder film was evaluated for its tensile breaking strength, wettability to electrolysis solution, and water resistance. The results are shown in Table 1.

### <Preparation of Slurry Composition for Secondary-Battery Negative Electrode>

A planetary mixer was charged with 10000 parts of natural graphite (amorphous-coated natural graphite, BET specific surface area: 3.0 m²/g, average particle diameter: 13 μm) being the carbon-based active material; 98 parts of 1% aqueous solution of CMC1, in terms of solid content, and 2 parts of 1% aqueous solution of PAA1 (whose pH has been adjusted to pH 8 with NaOH), in terms of solid content, as the water-soluble thickener (A); 2 parts of the cross-linking agent B1, in terms of solid content, as the cross-linking agent (B); and 150 parts of the water dispersion of the particulate polymer C1, in terms of solid content, as the particulate polymer (C). To this, deionized water was further added and mixed such that the solid content concentration becomes 52%. In this manner, the slurry composition for secondary-battery negative electrode containing the secondary-battery binder composition that contains CMC1, PAA1, cross-linking agent B1, and particulate polymer C1 was prepared.

<Production of Negative Electrode>

The aforementioned slurry composition for secondary-battery negative electrode was applied onto copper foil (current collector) having a thickness of 20 μm, using a comma coater, such that the applied amount becomes 8.8 mg/cm² or more but 9.2 mg/cm² or less. The copper foil covered with the slurry composition for secondary-battery negative electrode was transported through an oven at 80° C. over 2 minutes and further through an oven at 120° C. over 2 minutes, at a rate of 0.3 m/min. The slurry composition applied onto the copper foil was thus dried and a web of negative electrode was obtained.

The web of negative electrode obtained was then pressed with a roll press such that the density of the mixed material layer becomes 1.45 g/cm³ or more, but 1.55 g/cm³ or less. Further, for the purpose of further promoting water removal and cross-linking, the web was left for 10 hours in an environment of a vacuum at 120° C. In this manner, a negative electrode obtained by forming a negative-electrode mixed material layer on the current collector was obtained.

Using the negative electrode as prepared, the adherence between the negative-electrode mixed material layer and the current collector, the injectability of electrolysis solution, and the water resistance of negative electrode were evaluated. The results are shown in Table 1.

<Production of Positive Electrode>

A planetary mixer was charged with 100 parts of LiCoO₂ as a positive electrode active material, 2 parts of acetylene black (“HS-100”, manufactured by DENKI KAGAKU KOGYO KABUSHIKI KAISHA) as a conductive material, and 2 parts of PVDF (polyvinylidene fluoride, “KF-1100” manufactured by KUREHA CORPORATION). To this, N-methylpyrrolidone was further added to adjust the total solid-content concentration to 67%. The contents were then mixed, and a slurry composition for secondary-battery positive electrode was prepared.

The slurry composition for secondary-battery positive electrode obtained was applied onto aluminum foil having a thickness of 20 μm using a comma coater, and then was dried. This drying was performed by transporting the aluminum foil through an oven at 60° C. at a rate of 0.5 m/min over 2 minutes. After that, the aluminum foil was heat-treated for 2 minutes at 120° C., and a web of positive electrode was obtained.

The web of positive electrode obtained was then pressed with a roll press such that the density of the mixed material layer after pressing becomes 3.40 g/cm³ or more, but 3.50 g/cm³ or less. Further, for the purpose of removing water, the web was left for 3 hours in an environment of a vacuum at 120° C. In this manner, a positive electrode obtained by forming a positive-electrode mixed material layer on the current collector was obtained.

<Production of Lithium Ion Secondary Battery>

A single-layer separator made of polypropylene (having a width of 65 mm, a length of 500 mm, and a thickness of 25 μm; produced by a dry method; and having a porosity of 55%) was prepared, and a square piece having a size of 5 cm by 5 cm was cut out of the separator. Further, an aluminum packing case was prepared as a case of the battery.

The positive electrode as prepared was then cut into a rectangular piece having a size of 3.8 cm by 2.8 cm, and the positive electrode piece was arranged such that the surface of the current-collector side contacts with the aluminum packing case. On the side of the positive-electrode mixed material layer of the positive electrode, the aforementioned square separator was arranged. Further, the negative electrode as prepared was cut into a rectangular piece having a size of 4.0 cm by 3.0 cm, and this rectangular piece was arranged on the separator such that the surface of the negative-electrode mixed material layer side faces the separator. Then, a LiPF₆ solution at a concentration of 1.0 M was charged as an electrolysis solution. The solvent of the LiPF₆ solution was a mixture solvent of ethylene carbonate (EC)/ethylmethyl carbonate (EMC)=½ (volume ratio), which contains 2 volume % vinylene carbonate (in terms of solvent ratio) as an additive. The aluminum exterior package was then closed by heat sealing at 150° C. to tightly seal up the opening of the aluminum packaging material. In this manner, a lithium ion secondary battery of laminated cell was produced.

The lithium ion secondary battery as prepared was evaluated for its cycle characteristics and for its resistance increase suppression after cycles. The results are shown in Table 1.

### Examples 2, 3, 9, 10, and 16-19

Other than changing the blending amounts of the cross-linking agent B1 to 5, 10, 20, 50, 0.01, 0.6, 1, and 80 parts, in terms of solid content, respectively, the procedure of Example 1 was followed to produce secondary-battery binder compositions, slurry compositions for secondary-battery negative electrode, negative electrodes, positive electrodes, and lithium ion secondary batteries. The products were then evaluated in the same manner as the products of Example 1. The results are shown in Tables 1 and 2.

### Examples 4-5

Other than using the cross-linking agent B2 and the cross-linking agent B3, respectively, in place of the cross-linking agent B1, the procedure of Example 2 was followed to produce secondary-battery binder compositions, slurry compositions for secondary-battery negative electrode, negative electrodes, positive electrodes, and lithium ion secondary batteries. The products were then evaluated in the same manner as the products of Example 1. The results are shown in Table 1.

### Examples 6-8

Other than using, as the water-soluble thickener (A), 100 parts of CMC1 alone, 99.5 parts of CMC1 and 0.5 parts of PAA1, and 90 parts of CMC1 and 10 parts of PAA1, in terms of solid content, respectively, the procedure of Example 2 was followed to produce secondary-battery binder compositions, slurry compositions for secondary-battery negative electrode, negative electrodes, positive electrodes, and lithium ion secondary batteries. The products were then evaluated in the same manner as the products of Example 1. The results are shown in Table 1.

### Examples 11-15

Other than changing the blending amounts of the particulate polymer C1 to 15, 60, 100, 270, and 400 parts, in terms of solid content, respectively, the procedure of Example 2 was followed to produce secondary-battery binder compositions, slurry compositions for secondary-battery negative electrode, negative electrodes, positive electrodes, and lithium ion secondary batteries. The products were then evaluated in the same manner as the products of Example 1. The results are shown in Table 2.

### Example 20

Other than using artificial graphite (BET specific surface area: 3.7 m²/g, average particle diameter: 23 μm) as the negative electrode active material, the procedure of Example 2 was followed to produce a secondary-battery binder composition, a slurry compositions for secondary-battery negative electrode, a negative electrode, a positive electrode, and a lithium ion secondary battery. The products were then evaluated in the same manner as the products of Example 1. The results are shown in Table 2.

### Example 21

Other than using a mixture of the natural graphite used in Example 1 and the artificial graphite used in Example 20 (the proportion of the natural graphite in the mixture: 50 mass %) as the negative electrode active material, the procedure of Example 2 was followed to produce a secondary-battery binder composition, a slurry composition for secondary-battery negative electrode, a negative electrode, a positive electrode, and a lithium ion secondary battery. The products were then evaluated in the same manner as the products of Example 1. The results are shown in Table 2.

### Comparative Examples 1, 5, 6

Other than not using the cross-linking agent B1, the procedures of Examples 1, 20, and 21 were followed to produce secondary-battery binder compositions, slurry compositions for secondary-battery negative electrode, negative electrodes, positive electrodes, and lithium ion secondary batteries. The products were then evaluated in the same manner as the products of Example 1. The results are shown in Table 3.

### Comparative Example 2

Other than changing the blending amount of the cross-linking agent B1 to 110 parts in terms of solid content, the procedure of Example 1 was followed to produce a secondary-battery binder composition, a slurry composition for secondary-battery negative electrode, a negative electrode, a positive electrode, and a lithium ion secondary battery. The products were then evaluated in the same manner as the products of Example 1. The results are shown in Table 3.

### Comparative Examples 3-4

Other than changing the blending amounts of the particulate polymer C1 to 510 and 3 parts, in terms of solid content, respectively, the procedure of Example 2 was followed to produce secondary-battery binder compositions, slurry compositions for secondary-battery negative electrode, negative electrodes, positive electrodes, and lithium ion secondary batteries. The products were then evaluated in the same manner as the products of Example 1. The results are shown in Table 3.

TABLE 1

| | | | | Example | Example | Example | Example | Example |
|---|---|---|---|---|---|---|---|---|
| | | | | 1 | 2 | 3 | 4 | 5 |
| Slurry | Binder | Water-soluble | CMC1 blending amount | 98 | 98 | 98 | 98 | 98 |
| composition | composition | thickener (A) | [mass parts] | | | | | |
| | | | PAA1 blending amount | 2 | 2 | 2 | 2 | 2 |
| | | | [mass parts] | | | | | |
| | | Crosslinking | Kind | B1 | B1 | B1 | B2 | B3 |
| | | agent (B) | Oxazoline equivalent | 70 | 70 | 70 | 220 | 550 |
| | | | One-phase aqueous | One-phase | One-phase | One-phase | One-phase | Emulsion |
| | | | solution or | aqueous | aqueous | aqueous | aqueous | |
| | | | emulsion | solution | solution | solution | solution | |
| | | | Blending amount | 2 | 5 | 10 | 5 | 5 |
| | | | [mass parts] | | | | | |
| | | Particulate | Kind | C1 | C1 | C1 | C1 | C1 |
| | | polymer (C) | Functional group | Carboxyl | Carboxyl | Carboxyl | Carboxyl | Carboxyl |
| | | | | group + | group + | group + | group + | group + |
| | | | | Hydroxy | Hydroxy | Hydroxy | Hydroxy | Hydroxy |
| | | | | group | group | group | group | group |
| | | | Gel content [mass %] | 92 | 92 | 92 | 92 | 92 |
| | | | Tg [° C.] | 10 | 10 | 10 | 10 | 10 |
| | | | Blending amount | 150 | 150 | 150 | 150 | 150 |
| | | | [mass parts] | | | | | |
| | Negative electrode | | Kind (graphite) | Natural | Natural | Natural | Natural | Natural |
| | active material | | Blending amount | 10000 | 10000 | 10000 | 10000 | 10000 |
| | | | [mass parts] | | | | | |
| Binder film | | Tensile breaking strength | | A | A | A | A | B |
| | | Wettability to electrolysis solution | | C | A | A | B | B |
| | | Water resistance | | A | A | A | A | C |
| Negative electrode/ | | Adherence between negative-electrode mixed | | A | A | A | A | B |
| Secondary battery | | material layer and current collector | | | | | | |
| | | Cycle characteristics | | A | A | B | B | C |
| | | Suppression of resistance increase after cycles | | A | A | A | A | B |
| | | Injectability of the electrolysis solution | | C | A | A | B | B |
| | | Water resistance | | A | A | A | A | C |
| | | | | Example | Example | Example | Example | Example |
| | | | | 6 | 7 | 8 | 9 | 10 |
| Slurry | Binder | Water-soluble | CMC1 blending amount | 100 | 99.5 | 90 | 98 | 98 |
| composition | composition | thickener (A) | [mass parts] | | | | | |
| | | | PAA1 blending amount | 0 | 0.5 | 10 | 2 | 2 |
| | | | [mass parts] | | | | | |
| | | Crosslinking | Kind | B1 | B1 | B1 | B1 | B1 |
| | | agent (B) | Oxazoline equivalent | 70 | 70 | 70 | 70 | 70 |
| | | | One-phase aqueous | One-phase | One-phase | One-phase | One-phase | One-phase |
| | | | solution or | aqueous | aqueous | aqueous | aqueous | aqueous |
| | | | emulsion | solution | solution | solution | solution | solution |
| | | | Blending amount | 5 | 5 | 5 | 20 | 50 |
| | | | [mass parts] | | | | | |
| | | Particulate | Kind | C1 | C1 | C1 | C1 | C1 |
| | | polymer (C) | Functional group | Carboxyl | Carboxyl | Carboxyl | Carboxyl | Carboxyl |
| | | | | group + | group + | group + | group + | group + |
| | | | | Hydroxy | Hydroxy | Hydroxy | Hydroxy | Hydroxy |
| | | | | group | group | group | group | group |
| | | | Gel content [mass %] | 92 | 92 | 92 | 92 | 92 |
| | | | Tg [° C.] | 10 | 10 | 10 | 10 | 10 |
| | | | Blending amount | 150 | 150 | 150 | 150 | 150 |
| | | | [mass parts] | | | | | |

| | | | | | | |
|---|---|---|---|---|---|---|
| Negative electrode | Kind (graphite) | Natural | Natural | Natural | Natural | Natural |
| active material | Blending amount | 10000 | 10000 | 10000 | 10000 | 10000 |
| | [mass parts] | | | | | |

| | | | | | | |
|---|---|---|---|---|---|---|
| Binder film | Tensile breaking strength | B | A | B | B | B |
| | Wettability to electrolysis solution | B | A | A | A | A |
| | Water resistance | B | A | A | A | B |
| Negative electrode/ | Adherence between negative-electrode mixed | B | B | B | B | C |
| Secondary battery | material layer and current collector | | | | | |
| | Cycle characteristics | B | A | B | C | C |
| | Suppression of resistance increase after cycles | B | A | A | B | B |
| | Injectability of the electrolysis solution | B | A | A | A | A |
| | Water resistance | B | A | A | A | B |

TABLE 2

| | | | | Example | Example | Example | Example | Example | Example |
|---|---|---|---|---|---|---|---|---|---|
| | | | | 11 | 12 | 13 | 14 | 15 | 16 |
| Slurry | Binder | Water-soluble | CMC1 blending amount | 98 | 98 | 98 | 98 | 98 | 98 |
| composition | composition | thickener (A) | [mass parts] | | | | | | |
| | | | PAA1 blending amount | 2 | 2 | 2 | 2 | 2 | 2 |
| | | | [mass parts] | | | | | | |
| | | Cross linking | Kind | B1 | B1 | B1 | B1 | B1 | B1 |
| | | agent (B) | Oxazoline equivalent | 70 | 70 | 70 | 70 | 70 | 70 |
| | | | One-phase aqueous | One-phase | One-phase | One-phase | One-phase | One-phase | One-phase |
| | | | solution or | aqueous | aqueous | aqueous | aqueous | aqueous | aqueous |
| | | | emulsion | solution | solution | solution | solution | solution | solution |
| | | | Blending amount | 5 | 5 | 5 | 5 | 5 | 0.01 |
| | | | [mass parts] | | | | | | |
| | | Particulate | Kind | C1 | C1 | C1 | C1 | C1 | C1 |
| | | polymer (C) | Functional group | Carboxyl | Carboxyl | Carboxyl | Carboxyl | Carboxyl | Carboxyl |
| | | | | group + | group + | group + | group + | group + | group + |
| | | | | Hydroxy | Hydroxy | Hydroxy | Hydroxy | Hydroxy | Hydroxy |
| | | | | group | group | group | group | group | group |
| | | | Gel content [mass %] | 92 | 92 | 92 | 92 | 92 | 92 |
| | | | Tg [° C.] | 10 | 10 | 10 | 10 | 10 | 10 |
| | | | Blending amount | 15 | 60 | 100 | 270 | 400 | 150 |
| | | | [mass parts] | | | | | | |

| | | | | | | | |
|---|---|---|---|---|---|---|---|
| Negative electrode | Kind (graphite) | Natural | Natural | Natural | Natural | Natural | Natural |
| active material | Blending amount | 10000 | 10000 | 10000 | 10000 | 10000 | 10000 |
| | [mass parts] | | | | | | |

| | | | | | | | |
|---|---|---|---|---|---|---|---|
| Binder film | Tensile breaking strength | A | A | A | B | C | C |
| | Wettability to electrolysis solution | A | A | A | B | C | C |
| | Water resistance | A | A | A | C | C | B |
| Negative electrode/ | Adherence between negative-electrode mixed | C | B | A | A | A | B |
| Secondary battery | material layer and current collector | | | | | | |
| | Cycle characteristics | B | B | A | B | C | B |
| | Suppression of resistance increase after cycles | B | B | A | A | B | B |
| | Injectability of the electrolysis solution | B | B | A | B | C | C |
| | Water resistance | B | B | A | B | C | B |

| | | | | Example | Example | Example | Example | Example |
|---|---|---|---|---|---|---|---|---|
| | | | | 17 | 18 | 19 | 20 | 21 |
| Slurry | Binder | Water-soluble | CMC1 blending amount | 98 | 98 | 98 | 98 | 98 |
| composition | composition | thickener (A) | [mass parts] | | | | | |
| | | | PAA1 blending amount | 2 | 2 | 2 | 2 | 2 |
| | | | [mass parts] | | | | | |
| | | Cross linking | Kind | B1 | B1 | B1 | B1 | B1 |
| | | agent (B) | Oxazoline equivalent | 70 | 70 | 70 | 70 | 70 |
| | | | One-phase aqueous | One-phase | One-phase | One-phase | One-phase | One-phase |
| | | | solution or | aqueous | aqueous | aqueous | aqueous | aqueous |
| | | | emulsion | solution | solution | solution | solution | solution |
| | | | Blending amount | 0.6 | 1 | 80 | 5 | 5 |
| | | | [mass parts] | | | | | |
| | | Particulate | Kind | C1 | C1 | C1 | C1 | C1 |
| | | polymer (C) | Functional group | Carboxyl | Carboxyl | Carboxyl | Carboxyl | Carboxyl |
| | | | | group + | group + | group + | group + | group + |
| | | | | Hydroxy | Hydroxy | Hydroxy | Hydroxy | Hydroxy |
| | | | | group | group | group | group | group |
| | | | Gel content [mass %] | 92 | 92 | 92 | 92 | 92 |
| | | | Tg [° C.] | 10 | 10 | 10 | 10 | 10 |
| | | | Blending amount | 150 | 150 | 150 | 150 | 150 |
| | | | [mass parts] | | | | | |

| | | | | | | |
|---|---|---|---|---|---|---|
| Negative electrode | Kind (graphite) | Natural | Natural | Natural | Artificial | Natural/ |
| active material | | | | | | Artificial |
| | Blending amount | 10000 | 10000 | 10000 | 10000 | 10000 |
| | [mass parts] | | | | | |

| | | | | | | |
|---|---|---|---|---|---|---|
| Binder film | Tensile breaking strength | C | B | C | A | A |
| | Wettability to electrolysis solution | C | C | A | A | A |
| | Water resistance | B | B | B | A | A |
| Negative electrode/ | Adherence between negative-electrode mixed | B | B | C | C | C |
| Secondary battery | material layer and current collector | | | | | |
| | Cycle characteristics | B | B | C | B | B |
| | Suppression of resistance increase after cycles | B | B | B | B | B |
| | Injectability of the electrolysis solution | C | C | A | C | C |
| | Water resistance | B | A | B | A | A |

TABLE 3

| | | | | Com. | Com. | Com. | Com. | Com. | Com. |
|---|---|---|---|---|---|---|---|---|---|
| | | | | Example | Example | Example | Example | Example | Example |
| | | | | 1 | 2 | 3 | 4 | 5 | 6 |
| Slurry | Binder | Water-soluble | CMC1 blending amount | 98 | 98 | 98 | 98 | 98 | 98 |
| composition | composition | thickener (A) | [mass parts] | | | | | | |
| | | | PAA1 blending amount | 2 | 2 | 2 | 2 | 2 | 2 |
| | | | [mass parts] | | | | | | |
| | | Cross linking | Kind | — | B1 | B1 | B1 | — | — |
| | | agent (B) | Oxazoline equivalent | — | 70 | 70 | 70 | — | — |
| | | | One-phase aqueous | — | One-phase | One-phase | One-phase | — | — |
| | | | solution or | | aqueous | aqueous | aqueous | | |
| | | | emulsion | | solution | solution | solution | | |
| | | | Blending amount | 0 | 110 | 5 | 5 | 0 | 0 |
| | | | [mass parts] | | | | | | |
| | | Particulate | Kind | C1 | C1 | C1 | C1 | C1 | C1 |
| | | polymer (C) | Functional group | Carboxyl | Carboxyl | Carboxyl | Carboxyl | Carboxyl | Carboxyl |
| | | | | group + | group + | group + | group + | group + | group + |
| | | | | Hydroxy | Hydroxy | Hydroxy | Hydroxy | Hydroxy | Hydroxy |
| | | | | group | group | group | group | group | group |
| | | | Gel content [mass %] | 92 | 92 | 92 | 92 | 92 | 92 |
| | | | Tg [° C.] | 10 | 10 | 10 | 10 | 10 | 10 |
| | | | Blending amount | 150 | 150 | 510 | 3 | 150 | 150 |
| | | | [mass parts] | | | | | | |

| | | | | | | | |
|---|---|---|---|---|---|---|---|
| Negative electrode | Kind (graphite) | Natural | Natural | Natural | Natural | Artificial | Natural/ |
| active material | | | | | | | Artificial |
| | Blending amount | 10000 | 10000 | 10000 | 10000 | 10000 | 10000 |
| | [mass parts] | | | | | | |

| | | | | | | | |
|---|---|---|---|---|---|---|---|
| Binder film | Tensile breaking strength | D | C | C | C | D | D |
| | Wettability to electrolysis solution | D | A | C | A | D | D |
| | Water resistance | D | C | C | A | D | D |
| Negative electrode/ | Adherence between negative-electrode mixed | D | D | A | C | D | D |
| Secondary battery | material layer and current collector | | | | | | |
| | Cycle characteristics | D | D | C | C | D | D |
| | Suppression of resistance increase after cycles | D | D | D | C | D | D |
| | Injectability of the electrolysis solution | D | C | D | C | D | D |
| | Water resistance | D | C | C | C | D | D |

The above results demonstrate that Examples 1-21, which use the predetermined water-soluble thickener (A), an oxazoline compound as the cross-linking agent (B), and the particulate polymer (C) at specific ratios, can ensure the close adherence between the negative-electrode mixed material layer and the current collector as well as the injectability of the electrolysis solution, and improve the electrical characteristics of the lithium ion secondary battery. The Examples 1-21 further show that the water resistance of the negative electrode is also improved.

In contrast to this, Comparative Examples 1, 5, and 6, which do not contain the cross-linking agent (B), fail to ensure the close adherence between the negative-electrode mixed material layer and the current collector as well as the injectability of the electrolysis solution, and fail to improve the electrical characteristics of the lithium ion secondary battery. Comparative Examples 1, 5, and 6 further show that the water resistance of the negative electrode is low.

In this regard, the Comparative Example 2, whose blending amount of the cross-linking agent (B) is larger than the predetermined amount, fails ensure the close adherence between the negative-electrode mixed material layer and the current collector, and fails to improve the electrical characteristics of the lithium ion secondary battery.

Also, the Comparative Example 3, whose blending amount of the particulate polymer (C) is larger than the predetermined amount, fails to ensure the injectability of the electrolysis solution, and fails to improve the electrical characteristics of the lithium ion secondary battery.

Further, the Comparative Example 4, which contains the particulate polymer (C) but the blending amount thereof is smaller than the predetermined amount, fails to improve the close adherence between the negative-electrode mixed material layer and the current collector as well as the injectability of the electrolysis solution in a balanced manner.

In particular, Examples 1-3, 9, 10, and 16-19 demonstrate that by adjusting the blending ratio of the cross-linking agent (B) to the water-soluble thickener (A), the close adherence between the negative-electrode mixed material layer and the current collector, the injectability of electrolysis solution, the electrical characteristics of the lithium ion secondary battery, and the water resistance of negative electrode can be concurrently achieved at high levels.

Examples 2 and 4 demonstrate that by changing the oxazoline equivalent of the cross-linking agent (B), the injectability of electrolysis solution, the electrical characteristics of the lithium ion secondary battery can be concurrently achieved at high levels.

Examples 2, 4, and 5 demonstrate that with the cross-linking agent (B) being a one-phase aqueous solution, the close adherence between the negative-electrode mixed material layer and the current collector, the injectability of electrolysis solution, the electrical characteristics of lithium ion secondary battery, and the water resistance of negative electrode can be concurrently achieved at high levels.

Examples 2 and 6-8 demonstrate that by using carboxymethyl cellulose and polyacrylic acid in combination as the water-soluble thickener (A) and adjusting the blending ratio thereof, the close adherence between the negative-electrode mixed material layer and the current collector, the injectability of electrolysis solution, the electrical characteristics of the lithium ion secondary battery, and the water resistance of negative electrode can be concurrently achieved at high levels.

Examples 2 and 11-15 demonstrate that by adjusting the blending ratio of the particulate polymer (C) to the water-soluble thickener (A), the close adherence between the negative-electrode mixed material layer and the current collector, the injectability of electrolysis solution, the electrical characteristics of the lithium ion secondary battery, and the water resistance of negative electrode can be concurrently achieved at high levels.

Examples 2, 20, and 21 demonstrate that by changing the kind of graphite used as the negative electrode active material, the close adherence between the negative-electrode mixed material layer and the current collector, the injectability of electrolysis solution, and the electrical characteristics of the lithium ion secondary battery can be concurrently achieved at high levels.

Next, in Examples 22-42 and Comparative Examples 7-12, a carbodiimide compound was used as the cross-linking agent (B) to make secondary-battery binder compositions, slurry compositions for secondary-battery negative electrode, secondary-battery negative electrodes, and secondary batteries; and the products were evaluated.

(Materials Used)

The aforementioned CMC1 and PAA1 were used as the water-soluble thickener (A), the aforementioned particulate polymer C1 was used as the particulate polymer (C), and the following cross-linking agent (B) was used.

### [Cross-Linking Agent (B)]

Cross-linking agent B4: polycarbodiimide (manufacturer: Nisshinbo Chemical Inc., product name: CARBODILITE (registered trademark) SV-02, NCN equivalent: 429, one-phase aqueous solution)

Cross-linking agent B5: polycarbodiimide (manufacturer: Nisshinbo Chemical Inc., product name: CARBODILITE (registered trademark) V-02, NCN equivalent: 600, one-phase aqueous solution)

Cross-linking agent B6: polycarbodiimide (manufacturer: Nisshinbo Chemical Inc., product name: CARBODILITE (registered trademark) E-02, NCN equivalent: 445, emulsion)

### Example 22

### Preparation of Secondary-Battery Binder Composition

Two parts of the cross-linking agent B4, in terms of solid content, as the cross-linking agent (B) and 150 parts of the particulate polymer C1, in terms of solid content, as the particulate polymer (C) were mixed in an environment of 25° C. The mixture was then added to 100 mass parts of the water-soluble thickener (A) that consists of 98 mass parts of CMC1, in terms of solid content, and 2 mass parts of PAA1, also in terms of solid content, and the secondary-battery binder composition of Examples 22 was prepared.

Using the secondary-battery binder composition as prepared, a binder film was made by the aforementioned method. The binder film was evaluated for its tensile breaking strength, wettability to electrolysis solution, and water resistance. The results are shown in Table 4.

### <Preparation of Slurry Composition for Secondary-Battery Negative Electrode>

A planetary mixer was charged with 10000 parts of natural graphite (amorphous-coated natural graphite, BET specific surface area: 3.0 m²/g, average particle diameter: 13 μm) being the carbon-based active material; 98 parts of 1% aqueous solution of CMC1, in terms of solid content, and 2 parts of 1% aqueous solution of PAA1 (whose pH has been adjusted to pH 8 with NaOH), in terms of solid content, as the water-soluble thickener (A); 2 parts of the cross-linking agent B4, in terms of solid content, as the cross-linking agent (B); and 150 parts of the water dispersion of the particulate polymer C1, in terms of solid content, as the particulate polymer (C). To this, deionized water was further added and mixed such that the solid content concentration becomes 52%. In this manner, the slurry composition for secondary-battery negative electrode containing the secondary-battery binder composition that contains CMC1, PAA1, cross-linking agent B4, and particulate polymer C1 was prepared.

<Production of Negative Electrode>

The aforementioned slurry composition for secondary-battery negative electrode was applied onto copper foil (current collector) having a thickness of 20 μm, using a comma coater, such that the applied amount becomes 8.8 mg/cm² or more but 9.2 mg/cm² or less. The copper foil covered with the slurry composition for secondary-battery negative electrode was transported through an oven at 80° C. over 2 minutes and further through an oven at 120° C. over 2 minutes, at a rate of 0.3 m/min. The slurry composition applied onto the copper foil was thus dried and a web of negative electrode was obtained.

The web of negative electrode obtained was then pressed with a roll press such that the density of the mixed material layer becomes 1.45 g/cm³ or more, but 1.55 g/cm³ or less. Further, for the purpose of further promoting water removal and cross-linking, the web was left for 10 hours in an environment of a vacuum at 120° C. In this manner, a negative electrode obtained by forming a negative-electrode mixed material layer on the current collector was obtained.

Using the negative electrode as prepared, the adherence between the negative-electrode mixed material layer and the current collector, the injectability of electrolysis solution, and the water resistance of negative electrode were evaluated. The results are shown in Table 4.

<Production of Positive Electrode>

A planetary mixer was charged with 100 parts of LiCoO₂ as a positive electrode active material, 2 parts of acetylene black (“HS-100”, manufactured by DENKI KAGAKU KOGYO KABUSHIKI KAISHA) as a conductive material, 2 parts of PVDF (polyvinylidene fluoride, “KF-1100” manufactured by KUREHA CORPORATION). To this, N-methylpyrrolidone was further added to adjust the total solid-content concentration to 67%. The contents were then mixed, and the slurry composition for secondary-battery positive electrode was prepared.

The slurry composition for secondary battery positive electrode obtained was applied onto aluminum foil having a thickness of 20 μm using a comma coater, and then was dried. This drying was performed by transporting the aluminum foil through an oven at 60° C. at a rate of 0.5 m/min over 2 minutes. After that, the aluminum foil was heat-treated for 2 minutes at 120° C., and a web of positive electrode was thus obtained.

The web of positive electrode obtained was dried and then pressed with a roll press such that the density of the mixed material layer after pressing becomes 3.40 g/cm³ or more, but 3.50 g/cm³ or less. Further, for the purpose of removing water, the web was left for 3 hours in an environment of a vacuum at 120° C. In this manner, a positive electrode obtained by forming a positive-electrode mixed material layer on the current collector was obtained.

<Production of Lithium Ion Secondary Battery>

A single-layer separator made of polypropylene (having a width of 65 mm, a length of 500 mm, and a thickness of 25 μm; produced by a dry method; and having a porosity of 55%) was prepared, and a square piece having a size of 5 cm by 5 cm was cut out of the separator. Further, an aluminum packing case was prepared as a case of the battery.

The positive electrode as prepared was then cut into a rectangular piece having a size of 3.8 cm by 2.8 cm, and the positive electrode piece was arranged such that the surface of the current-collector side contacts with the aluminum packing case. On the side of the positive-electrode mixed material layer of the positive electrode, the aforementioned square separator was arranged. Further, the negative electrode as prepared was cut into a rectangular piece having a size of 4.0 cm by 3.0 cm, and this rectangular piece was arranged on the separator such that the surface of the negative-electrode mixed material layer side faces the separator. Then, a LiPF₆ solution at a concentration of 1.0 M was charged as an electrolysis solution. The solvent of the LiPF₆ solution was a mixture solvent of ethylene carbonate (EC)/ethylmethyl carbonate (EMC)=½ (volume ratio), which contains 2 volume % vinylene carbonate (in terms of solvent ratio) as an additive. The aluminum exterior package was then closed by heat sealing at 150° C. to tightly seal up the opening of the aluminum packaging material. In this matter, a lithium ion secondary battery of laminated cell was produced.

The lithium ion secondary battery as prepared was evaluated for its cycle characteristics and for its resistance increase suppression after cycles. The results are shown in Table 4.

### Examples 23, 24, 30, 31, 37-40

Other than changing the blending amounts of the cross-linking agent B4 to 5, 10, 20, 50, 0.01, 0.6, 1, and 80 parts, in terms of solid content, respectively, the procedure of Example 22 was followed to produce secondary-battery binder compositions, slurry compositions for secondary-battery negative electrode, negative electrodes, positive electrodes, and lithium ion secondary batteries. The products were then evaluated in the same manner as the products of Example 22. The results are shown in Tables 4 and 5.

### Examples 25-26

Other than using the cross-linking agent B5 and the cross-linking agent B6, respectively, in place of the cross-linking agent B4, the procedure of Example 23 was followed to produce secondary-battery binder compositions, slurry compositions for secondary-battery negative electrode, negative electrodes, positive electrodes, and lithium ion secondary batteries. The products were then evaluated in the same manner as the products of Example 22. The results are shown in Table 4.

### Examples 27-29

Other than using, as the water-soluble thickener (A), 100 parts of CMC1 alone, 99.5 parts of CMC1 and 0.5 parts of PAA1, and 90 parts of CMC1 and 10 parts of PAA1, respectively, in terms of solid content, the procedure of Example 23 was followed to produce secondary-battery binder compositions, slurry compositions for secondary-battery negative electrode, negative electrodes, positive electrodes, and lithium ion secondary batteries. The products were then evaluated in the same manner as the products of Example 22. The results are shown in Table 4.

### Examples 32-36

Other than changing the blending amounts of the particulate polymer C1 to 15, 60, 100, 270, and 400 parts, respectively, in terms of solid content, the procedure of Example 23 was followed to produce secondary-battery binder compositions, slurry compositions for secondary-battery negative electrode, negative electrodes, positive electrodes, and lithium ion secondary batteries. The products were then evaluated in the same manner as the products of Example 22. The results are shown in Table 5.

### Example 41

Other than using artificial graphite (BET specific surface area: 3.7 m²/g, average particle diameter: 23 μm) as the negative electrode active material, the procedure of Example 23 was followed to produce a secondary-battery binder composition, a slurry composition for secondary-battery negative electrode, a negative electrode, a positive electrode, and a lithium ion secondary battery. The products were then evaluated in the same manner as the products of Example 22. The results are shown in Table 5.

### Example 42

Other than using a mixture of the natural graphite used in Example 22 and the artificial graphite used in Example 41 (the proportion of the natural graphite in the mixture: 50 mass %) as the negative electrode active material, the procedure of Example 23 was followed to produce a secondary-battery binder composition, a slurry compositions for secondary-battery negative electrode, a negative electrode, a positive electrode, and a lithium ion secondary battery. The products were then evaluated in the same manner as the products of Example 22. The results are shown in Table 5.

### Comparative Examples 7, 11, 12

Other than not using the cross-linking agent B4, the procedures of Examples 22, 41, and 42 were followed to produce secondary-battery binder compositions, slurry compositions for secondary-battery negative electrode, negative electrodes, positive electrodes, and lithium ion secondary batteries. The products were then evaluated in the same manner as the products of Example 22. The results are shown in Table 6.

### Comparative Example 8

Other than changing the blending amount of the cross-linking agent B4 to 110 parts in terms of solid content, the procedure of Example 22 was followed to produce a secondary-battery binder composition, a slurry composition for secondary-battery negative electrode, a negative electrode, a positive electrode, and a lithium ion secondary battery. The products were then evaluated in the same manner as the products of Example 22. The results are shown in Table 6.

### Comparative Examples 9-10

Other than changing the blending amounts of the particulate polymer C1 to 510 and 3 parts, respectively, in terms of solid content, the procedure of Example 23 was followed to produce secondary-battery binder compositions, slurry compositions for secondary-battery negative electrode, negative electrodes, positive electrodes, and lithium ion secondary batteries. The products were then evaluated in the same manner as the products of Example 22. The results are shown in Table 6.

TABLE 4

| | | | | Example | Example | Example | Example | Example |
|---|---|---|---|---|---|---|---|---|
| | | | | 22 | 23 | 24 | 25 | 26 |
| Slurry | Binder | Water-soluble | CMC1 blending amount | 98 | 98 | 98 | 98 | 98 |
| composition | composition | thickener (A) | [mass parts] | | | | | |
| | | | PAA1 blending amount | 2 | 2 | 2 | 2 | 2 |
| | | | [mass parts] | | | | | |
| | | Crosslinking | Kind | B4 | B4 | B4 | B5 | B6 |
| | | agent (B) | NCN equivalent | 429 | 429 | 429 | 600 | 445 |
| | | | One-phase | One-phase | One-phase | One-phase | One-phase | Emulsion |
| | | | aqueous solution or | aqueous | aqueous | aqueous | aqueous | |
| | | | emulsion | solution | solution | solution | solution | |
| | | | Blending amount | 2 | 5 | 10 | 5 | 5 |
| | | | [mass parts] | | | | | |
| | | Particulate | Kind | C1 | C1 | C1 | C1 | C1 |
| | | polymer (C) | Functional group | Carboxyl | Carboxyl | Carboxyl | Carboxyl | Carboxyl |
| | | | | group + | group + | group + | group + | group + |
| | | | | Hydroxy | Hydroxy | Hydroxy | Hydroxy | Hydroxy |
| | | | | group | group | group | group | group |
| | | | Gel content [mass %] | 92 | 92 | 92 | 92 | 92 |
| | | | Tg [° C.] | 10 | 10 | 10 | 10 | 10 |
| | | | Blending amount | 150 | 150 | 150 | 150 | 150 |
| | | | [mass parts] | | | | | |
| | Negative electrode | | Kind (graphite) | Natural | Natural | Natural | Natural | Natural |
| | active material | | Blending amount | 10000 | 10000 | 10000 | 10000 | 10000 |
| | | | [mass parts] | | | | | |
| Binder film | | Tensile breaking strength | | A | A | A | A | B |
| | | Wettability to electrolysis solution | | C | A | A | B | B |
| | | Water resistance | | A | A | A | A | C |
| Negative electrode/ | | Adherence between negative-electrode mixed | | A | A | A | A | B |
| Secondary battery | | material layer and current collector | | | | | | |
| | | Cycle characteristics | | A | A | B | B | C |
| | | Suppression of resistance increase after cycles | | A | A | A | A | B |
| | | Injectability of the electrolysis solution | | C | A | A | B | B |
| | | Water resistance | | A | A | A | A | C |
| | | | | Example | Example | Example | Example | Example |
| | | | | 27 | 28 | 29 | 30 | 31 |
| Slurry | Binder | Water-soluble | CMC1 blending amount | 100 | 99.5 | 90 | 98 | 98 |
| composition | composition | thickener (A) | [mass parts] | | | | | |
| | | | PAA1 blending amount | 0 | 0.5 | 10 | 2 | 2 |
| | | | [mass parts] | | | | | |
| | | Crosslinking | Kind | B4 | B4 | B4 | B4 | B4 |
| | | agent (B) | NCN equivalent | 429 | 429 | 429 | 429 | 429 |
| | | | One-phase | One-phase | One-phase | One-phase | One-phase | One-phase |
| | | | aqueous solution or | aqueous | aqueous | aqueous | aqueous | aqueous |
| | | | emulsion | solution | solution | solution | solution | solution |
| | | | Blending amount | 5 | 5 | 5 | 20 | 50 |
| | | | [mass parts] | | | | | |
| | | Particulate | Kind | C1 | C1 | C1 | C1 | C1 |
| | | polymer (C) | Functional group | Carboxyl | Carboxyl | Carboxyl | Carboxyl | Carboxyl |
| | | | | group + | group + | group + | group + | group + |
| | | | | Hydroxy | Hydroxy | Hydroxy | Hydroxy | Hydroxy |
| | | | | group | group | group | group | group |
| | | | Gel content [mass %] | 92 | 92 | 92 | 92 | 92 |
| | | | Tg [° C.] | 10 | 10 | 10 | 10 | 10 |
| | | | Blending amount | 150 | 150 | 150 | 150 | 150 |
| | | | [mass parts] | | | | | |

| | | | | | | |
|---|---|---|---|---|---|---|
| Negative electrode | Kind (graphite) | Natural | Natural | Natural | Natural | Natural |
| active material | Blending amount | 10000 | 10000 | 10000 | 10000 | 10000 |
| | [mass parts] | | | | | |

| | | | | | | |
|---|---|---|---|---|---|---|
| Binder film | Tensile breaking strength | B | A | B | B | B |
| | Wettability to electrolysis solution | B | A | A | A | A |
| | Water resistance | B | A | A | A | B |
| Negative electrode/ | Adherence between negative-electrode mixed | B | B | B | B | C |
| Secondary battery | material layer and current collector | | | | | |
| | Cycle characteristics | B | A | B | C | C |
| | Suppression of resistance increase after cycles | B | A | A | B | B |
| | Injectability of the electrolysis solution | B | A | A | A | A |
| | Water resistance | B | A | A | A | B |

TABLE 5

| | | | | Example | Example | Example | Example | Example | Example |
|---|---|---|---|---|---|---|---|---|---|
| | | | | 32 | 33 | 34 | 35 | 36 | 37 |
| Slurry | Binder | Water-soluble | CMC1 blending amount | 98 | 98 | 98 | 98 | 98 | 98 |
| composition | composition | thickener (A) | [mass parts] | | | | | | |
| | | | PAA1 blending amount | 2 | 2 | 2 | 2 | 2 | 2 |
| | | | [mass parts] | | | | | | |
| | | Cross linking | Kind | B4 | B4 | B4 | B4 | B4 | B4 |
| | | agent (B) | NCN equivalent | 429 | 429 | 429 | 429 | 429 | 429 |
| | | | One-phase | One-phase | One-phase | One-phase | One-phase | One-phase | One-phase |
| | | | aqueous solution or | aqueous | aqueous | aqueous | aqueous | aqueous | aqueous |
| | | | emulsion | solution | solution | solution | solution | solution | solution |
| | | | Blending amount | 5 | 5 | 5 | 5 | 5 | 0.01 |
| | | | [mass parts] | | | | | | |
| | | Particulate | Kind | C1 | C1 | C1 | C1 | C1 | C1 |
| | | polymer (C) | Functional group | Carboxyl | Carboxyl | Carboxyl | Carboxyl | Carboxyl | Carboxyl |
| | | | | group + | group + | group + | group + | group + | group + |
| | | | | Hydroxy | Hydroxy | Hydroxy | Hydroxy | Hydroxy | Hydroxy |
| | | | | group | group | group | group | group | group |
| | | | Gel content [mass %] | 92 | 92 | 92 | 92 | 92 | 92 |
| | | | Tg [° C.] | 10 | 10 | 10 | 10 | 10 | 10 |
| | | | Blending amount | 15 | 60 | 100 | 270 | 400 | 150 |
| | | | [mass parts] | | | | | | |

| | | | | | | | |
|---|---|---|---|---|---|---|---|
| Negative electrode | Kind (graphite) | Natural | Natural | Natural | Natural | Natural | Natural |
| active material | Blending amount | 10000 | 10000 | 10000 | 10000 | 10000 | 10000 |
| | [mass parts] | | | | | | |

| | | | | | | | |
|---|---|---|---|---|---|---|---|
| Binder film | Tensile breaking strength | A | A | A | B | C | B |
| | Wettability to electrolysis solution | A | A | A | B | C | C |
| | Water resistance | A | A | A | C | C | B |
| Negative electrode/ | Adherence between negative-electrode mixed | C | B | A | A | A | B |
| Secondary battery | material layer and current collector | | | | | | |
| | Cycle characteristics | A | A | A | B | C | B |
| | Suppression of resistance increase after cycles | A | A | A | A | B | B |
| | Injectability of the electrolysis solution | A | A | A | B | C | C |
| | Water resistance | B | B | A | B | C | B |

| | | | | Example | Example | Example | Example | Example |
|---|---|---|---|---|---|---|---|---|
| | | | | 38 | 39 | 40 | 41 | 42 |
| Slurry | Binder | Water-soluble | CMC1 blending amount | 98 | 98 | 98 | 98 | 98 |
| composition | composition | thickener (A) | [mass parts] | | | | | |
| | | | PAA1 blending amount | 2 | 2 | 2 | 2 | 2 |
| | | | [mass parts] | | | | | |
| | | Cross linking | Kind | B4 | B4 | B4 | B4 | B4 |
| | | agent (B) | NCN equivalent | 429 | 429 | 429 | 429 | 429 |
| | | | One-phase | One-phase | One-phase | One-phase | One-phase | One-phase |
| | | | aqueous solution or | aqueous | aqueous | aqueous | aqueous | aqueous |
| | | | emulsion | solution | solution | solution | solution | solution |
| | | | Blending amount | 0.6 | 1 | 80 | 5 | 5 |
| | | | [mass parts] | | | | | |
| | | Particulate | Kind | C1 | C1 | C1 | C1 | C1 |
| | | polymer (C) | Functional group | Carboxyl | Carboxyl | Carboxyl | Carboxyl | Carboxyl |
| | | | | group + | group + | group + | group + | group + |
| | | | | Hydroxy | Hydroxy | Hydroxy | Hydroxy | Hydroxy |
| | | | | group | group | group | group | group |
| | | | Gel content [mass %] | 92 | 92 | 92 | 92 | 92 |
| | | | Tg [° C.] | 10 | 10 | 10 | 10 | 10 |
| | | | Blending amount | 150 | 150 | 150 | 150 | 150 |
| | | | [mass parts] | | | | | |

| | | | | | | |
|---|---|---|---|---|---|---|
| Negative electrode | Kind (graphite) | Natural | Natural | Natural | Artificial | Natural/ |
| active material | | | | | | Artificial |
| | Blending amount | 10000 | 10000 | 10000 | 10000 | 10000 |
| | [mass parts] | | | | | |

| | | | | | | |
|---|---|---|---|---|---|---|
| Binder film | Tensile breaking strength | B | A | C | A | A |
| | Wettability to electrolysis solution | C | C | A | A | A |
| | Water resistance | A | A | B | A | A |
| Negative electrode/ | Adherence between negative-electrode mixed | A | A | C | C | C |
| Secondary battery | material layer and current collector | | | | | |
| | Cycle characteristics | A | A | C | B | B |
| | Suppression of resistance increase after cycles | A | A | B | B | B |
| | Injectability of the electrolysis solution | C | C | A | C | C |
| | Water resistance | A | A | B | A | A |

TABLE 6

| | | | | Com. | Com. | Com. | Com. | Com. | Com. |
|---|---|---|---|---|---|---|---|---|---|
| | | | | Example | Example | Example | Example | Example | Example |
| | | | | 7 | 8 | 9 | 10 | 11 | 12 |
| Slurry | Binder | Water-soluble | CMC1 blending amount | 98 | 98 | 98 | 98 | 98 | 98 |
| composition | composition | thickener (A) | [mass parts] | | | | | | |
| | | | PAA1 blending amount | 2 | 2 | 2 | 2 | 2 | 2 |
| | | | [mass parts] | | | | | | |
| | | Crosslinking | Kind | — | B4 | B4 | B4 | — | — |
| | | agent (B) | NCN equivalent | — | 429 | 429 | 429 | — | — |
| | | | One-phase aqueous | — | One-phase | One-phase | One-phase | — | — |
| | | | solution or | | aqueous | aqueous | aqueous | | |
| | | | emulsion | | solution | solution | solution | | |
| | | | Blending amount | 0 | 110 | 5 | 5 | 0 | 0 |
| | | | [mass parts] | | | | | | |
| | | Particulate | Kind | C1 | C1 | C1 | C1 | C1 | C1 |
| | | polymer (C) | Functional group | Carboxyl | Carboxyl | Carboxyl | Carboxyl | Carboxyl | Carboxyl |
| | | | | group + | group + | group + | group + | group + | group + |
| | | | | Hydroxy | Hydroxy | Hydroxy | Hydroxy | Hydroxy | Hydroxy |
| | | | | group | group | group | group | group | group |
| | | | Gel content [mass %] | 92 | 92 | 92 | 92 | 92 | 92 |
| | | | Tg [° C.] | 10 | 10 | 10 | 10 | 10 | 10 |
| | | | Blending amount | 150 | 150 | 510 | 3 | 150 | 150 |
| | | | [mass parts] | | | | | | |

| | | | | | | | |
|---|---|---|---|---|---|---|---|
| Negative electrode | Kind (graphite) | Natural | Natural | Natural | Natural | Artificial | Natural/ |
| active material | | | | | | | Artificial |
| | Blending amount | 10000 | 10000 | 10000 | 10000 | 10000 | 10000 |
| | [mass parts] | | | | | | |

| | | | | | | | |
|---|---|---|---|---|---|---|---|
| Binder film | Tensile breaking strength | D | C | C | C | D | D |
| | Wettability to electrolysis solution | D | A | C | A | D | D |
| | Water resistance | D | C | C | A | D | D |
| Negative electrode/ | Adherence between negative-electrode mixed | D | D | A | C | D | D |
| Secondary battery | material layer and current collector | | | | | | |
| | Cycle characteristics | D | D | C | C | D | D |
| | Suppression of resistance increase after cycles | D | D | D | C | D | D |
| | Injectability of the electrolysis solution | D | C | D | C | D | D |
| | Water resistance | D | C | C | C | D | D |

The above results demonstrate that Examples 22-42, which use the predetermined water-soluble thickener (A), a carbodiimide compound as the cross-linking agent (B), and the particulate polymer (C) at specific ratios, can ensure the close adherence between the negative-electrode mixed material layer and the current collector as well as the injectability of the electrolysis solution, and improve the electrical characteristics of the lithium ion secondary battery. The Examples 22-42 further shows that the water resistance of the negative electrode is also improved.

In contrast to this, Comparative Examples 7, 11, and 12, which do not contain the cross-linking agent (B), fail to ensure the close adherence between the negative-electrode mixed material layer and the current collector as well as the injectability of the electrolysis solution, and fail to improve the electrical characteristics of the lithium ion secondary battery. Comparative Examples 7, 11, and 12 further show that the water resistance of the negative electrode is low.

In this regard, the Comparative Example 8, whose blending amount of the cross-linking agent (B) is larger than the predetermined amount, fails ensure the close adherence between the negative-electrode mixed material layer and the current collector, and fails to improve the electrical characteristics of the lithium ion secondary battery.

Also, the Comparative Example 9, whose blending amount of the particulate polymer (C) is larger than the predetermined amount, fails to ensure the injectability of the electrolysis solution, and fails to improve the electrical characteristics of the lithium ion secondary battery.

Further, the Comparative Example 10, which contains the particulate polymer (C) but the blending amount thereof is smaller than the predetermined amount, fails to improve the close adherence between the negative-electrode mixed material layer and the current collector as well as the injectability of the electrolysis solution in a balanced manner.

In particular, Examples 22-24, 30, 31, and 37-40 demonstrate that by adjusting the blending ratio of the cross-linking agent (B) to the water-soluble thickener (A), the close adherence between the negative-electrode mixed material layer and the current collector, the injectability of electrolysis solution, the electrical characteristics of the lithium ion secondary battery, and the water resistance of negative electrode can be concurrently achieved at high levels.

Examples 23 and 25 demonstrate that by changing the NCN equivalent of the cross-linking agent (B), the injectability of electrolysis solution and the electrical characteristics of the lithium ion secondary battery can be concurrently achieved at high levels.

Examples 23, 25, and 26 demonstrate that with the cross-linking agent (B) being a one-phase aqueous solution, the close adherence between the negative-electrode mixed material layer and the current collector, the injectability of electrolysis solution, the electrical characteristics of lithium ion secondary battery, and the water resistance of negative electrode can be concurrently achieved at high levels.

Examples 23 and 27-29 demonstrate that by using carboxymethyl cellulose and polyacrylic acid in combination as the water-soluble thickener (A) and adjusting the blending ratio thereof, the close adherence between the negative-electrode mixed material layer and the current collector, the injectability of electrolysis solution, the electrical characteristics of the lithium ion secondary battery, and the water resistance of negative electrode can be concurrently achieved at high levels.

Examples 23, and 32-36 demonstrate that by adjusting the blending ratio of the particulate polymer (C) to the water-soluble thickener (A), the close adherence between the negative-electrode mixed material layer and the current collector, the injectability of electrolysis solution, the electrical characteristics of the lithium ion secondary battery, and the water resistance of negative electrode can be concurrently achieved at high levels.

Examples 23, 41, and 42 demonstrate that by changing the kind of graphite used as the negative electrode active material, the close adherence between the negative-electrode mixed material layer and the current collector, the injectability of electrolysis solution, and the electrical characteristics of the lithium ion secondary battery can be concurrently achieved at high levels.

### INDUSTRIAL APPLICABILITY

The disclosed secondary-battery binder composition can provide good binding capacity and improve the electrical characteristics of the secondary battery that includes battery members formed with the binder composition. The disclosed slurry composition for secondary-battery electrode can form an electrode mixed material layer that demonstrates superior adherence to a current collector and can improve the electrical characteristics of the secondary battery.

The disclosed secondary-battery negative electrode can improve the adherence between the current collector and the negative-electrode mixed material layer as well as the electrical characteristics of the secondary battery.

The disclosed secondary battery can improve the electrical characteristics and ensure the adherence between the negative-electrode mixed material layer and the current collector.

1. A secondary-battery binder composition, comprising: a water-soluble thickener (A) having a hydroxy group or a carboxyl group; a cross-linking agent (B) having a carbodiimide group or an oxazoline group; and a particulate polymer (C), wherein
the particulate polymer (C) has a functional group reactive with the cross-linking agent (B), and contains an aliphatic conjugated diene monomer unit and an aromatic vinyl monomer unit, and
the secondary-battery binder composition contains 0.001 mass parts or more but less than 100 mass parts of the cross-linking agent (B) and 10 mass parts or more but less than 500 mass parts of the particulate polymer (C) per 100 mass parts of the water-soluble thickener (A).

2. The secondary-battery binder composition according to claim 1, wherein the water-soluble thickener (A) is at least one selected from the group consisting of: carboxymethyl cellulose, methyl cellulose, hydroxypropyl methylcellulose, hydroxyethyl methylcellulose, polyvinyl alcohol, polycarboxilic acid, and salts thereof.

3. The secondary-battery binder composition according to claim 1, wherein the functional group reactive with the cross-linking agent (B) in the particulate polymer (C) is at least one group selected from the group consisting of a carboxyl group, a hydroxy group, a glycidyl ether group, and a thiol group.

4. A slurry composition for secondary-battery electrode, comprising: a water-soluble thickener (A) having a hydroxy group or a carboxyl group; a cross-linking agent (B) having a carbodiimide group or an oxazoline group; a particulate polymer (C); an electrode active material; and water, wherein
the particulate polymer (C) has a functional group reactive with the cross-linking agent (B), and contains an aliphatic conjugated diene monomer unit and an aromatic vinyl monomer unit, and
the slurry composition for secondary-battery electrode contains 0.001 mass parts or more but less than 100 mass parts of the cross-linking agent (B) and 10 mass parts or more but less than 500 mass parts of the particulate polymer (C) per 100 mass parts of the water-soluble thickener (A).

5. A secondary-battery negative electrode, comprising a negative-electrode mixed material layer obtained from the slurry composition for secondary-battery electrode according to claim 4, wherein the electrode active material is a negative electrode active material.

6. The secondary-battery negative electrode according to claim 5, wherein the negative-electrode mixed material layer has crosslinked structures formed by the water-soluble thickener (A), the cross-linking agent (B), and the particulate polymer (C).

7. A secondary battery comprising: the secondary-battery negative electrode according to claim 5, a positive electrode, an electrolysis solution, and a separator.
